(19) United States
(12) Patent Application Publication
(10) Pub. No.: US 2015/0327243 A1
(43) Pub. Date: Nov. 12, 2015

(54) SYSTEMS AND METHODS FOR DUAL-CONNECTIVITY OPERATION

(71) Applicant: Sharp Laboratories of America, Inc., Camas, WA (US)

(72) Inventors: Zhanping Yin, Vancouver, WA (US); Shohei Yamada, Camas, WA (US)

(73) Assignee: Sharp Laboratories of America, Inc., Camas, WA (US)

(21) Appl. No.: 14/273,460

(22) Filed: May 8, 2014

(51) Int. Cl. H04W 72/04; H04L 5/00; H04W 52/14; H04W 52/40

(52) U.S. Cl. CPC H04W 72/0413; H04W 52/40; H04L 5/0032; H04W 52/146; H04W 88/02

(57) ABSTRACT

A user equipment (UE) is described. The UE determines that dual-connectivity is configured with more than one cell group. The UE also determines if a total scheduled transmission power of the cell groups exceeds a maximum allowed transmission power of the UE. The UE further determines a priority of uplink control information (UCI) types and channel types among the cell groups. The UE additionally determines if UCI is carried on a physical uplink shared channel (PUSCH) transmission for a cell group. The UE also determines if total transmission power of all cell groups with UCI-only transmissions exceeds the maximum allowed transmission power of the UE. The UE transmits UCI and channels on the cell groups.

### TECHNICAL FIELD

The present disclosure relates generally to communication systems. More specifically, the present disclosure relates to systems and methods for dual-connectivity operation.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and efficiency have been sought. However, improving communication capacity, speed, flexibility and efficiency may present certain problems.

For example, wireless communication devices may communicate with one or more devices using multiple connections. However, the multiple connections may only offer limited flexibility and efficiency. As illustrated by this discussion, systems and methods that improve communication flexibility and efficiency may be beneficial.

### BRIEF DESCRIPTION OF THE DRAWINGS

FIG. 1 is a block diagram illustrating one configuration of one or more evolved Node Bs (eNBs) and one or more user equipments (UEs) in which systems and methods for dual-connectivity operation may be implemented;

FIG. 2 is a block diagram illustrating configurations of E-UTRAN architecture in which systems and methods for dual-connectivity operation may be implemented;

FIG. 3 is a block diagram illustrating one configuration of an E-UTRAN and a UE in which systems and methods for dual-connectivity operation may be implemented;

FIG. 4 is a flow diagram illustrating one implementation of a method for dual-connectivity operation by a UE;

FIG. 5 is a flow diagram illustrating one implementation of a method for dual-connectivity operation by an eNB;

FIG. 6 illustrates a physical uplink shared channel (PUSCH) transmission structure with different uplink control information (UCI);

FIG. 7 illustrates a modified PUSCH transmission structure with different UCI;

FIG. 8 is a flow diagram illustrating a detailed implementation of a method for dual-connectivity operation by a UE;

FIG. 9 is a flow diagram illustrating another detailed implementation of a method for dual-connectivity operation by a UE;

FIG. 10 is a flow diagram illustrating yet another detailed implementation of a method for dual-connectivity operation by a UE;

FIG. 11 is a flow diagram illustrating another detailed implementation of a method for dual-connectivity operation by a UE;

FIG. 12 illustrates various components that may be utilized in a UE;

FIG. 13 illustrates various components that may be utilized in an eNB;

FIG. 14 is a block diagram illustrating one configuration of a UE in which systems and methods for sending feedback information may be implemented; and

FIG. 15 is a block diagram illustrating one configuration of an eNB in which systems and methods for receiving feedback information may be implemented.

### DETAILED DESCRIPTION

A user equipment (UE) is described. The UE includes a processor and memory in electronic communication with the processor. The UE determines that dual-connectivity is configured with more than one cell group. The UE also determines if a total scheduled transmission power of the cell groups exceeds a maximum allowed transmission power of the UE. The UE further determines a priority of uplink control information (UCI) types and channel types among the cell groups. The UE additionally determines if UCI is carried on a physical uplink shared channel (PUSCH) transmission for a cell group. The UE also determines if total transmission power of all cell groups with UCI-only transmissions exceeds the maximum allowed transmission power of the UE. The UE transmits UCI and channels on the cell groups.

If the total scheduled transmission power of the cell groups exceeds the maximum allowed transmission power of the UE, and if UCI is carried on a PUSCH transmission for a first cell group, and if a total transmission power of all cell groups with a UCI-only transmission on a PUSCH of the first cell group does not exceed the maximum allowed transmission power of the UE, then the UE may transmit the UCI only on the PUSCH of the first cell group.

If the total scheduled transmission power of the cell groups exceeds the maximum allowed transmission power of the UE, and if UCI is carried on a PUSCH transmission for a first cell group, and if a total transmission power of all cell groups with a UCI-only transmission on a PUSCH of the first cell group exceeds the maximum allowed transmission power of the UE, then the UE may transmit a channel with a higher priority in one cell group. The UE may also drop or power scale the channel of the other cell group.

If the total scheduled transmission power of the cell groups exceeds the maximum allowed transmission power of the UE, and if UCI is carried on a PUSCH transmission for a first cell group, and if a total transmission power of all the cell groups with UCI on a physical uplink control channel (PUCCH) of the first cell group does not exceed the maximum allowed transmission power of the UE, then the UE may transmit the UCI on PUCCH of the first cell group. The UE may also drop the PUSCH transmission of the first cell group.

If the total scheduled transmission power of the cell groups exceeds the maximum allowed transmission power of the UE, and if UCI is carried on a PUSCH transmission for a first cell group, and if a total transmission power of all cell groups with UCI on a PUCCH of the first cell group exceeds the maximum allowed transmission power of the UE, then the UE may transmit the channel with a higher priority in one cell group. The UE may also drop or power scale the channel on the other cell group.

Another UE is also described. The UE includes a processor and memory in electronic communication with the processor. The UE determines that dual-connectivity is configured with more than one cell group. The UE also determines if a total scheduled transmission power of the cell groups exceeds a maximum allowed transmission power of the UE.

If the total scheduled transmission power of the cell groups exceeds the maximum allowed transmission power of the UE, and if UCI is carried on a PUSCH transmission for a secondary cell group (SCG), and if a total transmission power of all cell groups with a UCI-only transmission on a PUSCH of the SCG does not exceed the maximum allowed transmission power of the UE, then the UE may transmit the UCI only on the PUSCH of the SCG.

If the total scheduled transmission power of the cell groups exceeds the maximum allowed transmission power of the UE, and if UCI is carried on a PUSCH transmission for an SCG, and if a total transmission power of all cell groups with the UCI on a PUCCH of the SCG instead of a PUSCH of the SCG does not exceed the maximum allowed transmission power of the UE, then the UE may transmit the UCI on the PUCCH of the SCG instead of the PUSCH of the SCG. The UE may also drop the PUSCH transmission of the SCG.

If the total scheduled transmission power of the cell groups exceeds the maximum allowed transmission power of the UE, and if UCI is carried on a PUSCH transmission for an SCG, and if a total transmission power of all cell groups with the UCI on a PUCCH of the SCG instead of a PUSCH of the SCG exceeds the maximum allowed transmission power of the UE, then the UE may drop or power scale the PUSCH with the UCI on the SCG.

If the total scheduled transmission power of the cell groups exceeds the maximum allowed transmission power of the UE, and if the total transmission power of PUSCH transmissions without UCI of serving cells of an SCG exceeds the maximum allowed transmission power of the UE minus allocated power for a master cell group (MCG) minus at least one of a PUCCH transmission with UCI or a PUSCH transmission with UCI of the serving cell of the SCG, then the UE may drop or power scale the PUSCH without UCI on the SCG.

An evolved NodeB (eNB) is also described. The eNB includes a processor and memory in electronic communication with the processor. The eNB determines that dual-connectivity is configured with more than one cell group. The eNB also receives UCI and channels on a cell group. The receiving is based on different assumptions of whether: a total scheduled transmission power of the cell groups exceeds a maximum allowed transmission power of a UE; a priority of UCI types and channel types among the cell groups; whether UCI is carried on a PUSCH transmission for a cell group; and whether a total transmission power of all cell groups with UCI-only transmissions exceeds the maximum allowed transmission power of the UE.

If the total scheduled transmission power of the cell groups exceeds the maximum allowed transmission power of the UE, and if UCI is carried on a PUSCH transmission for a first cell group, then the eNB may receive UCI only on a PUSCH of the first cell group when a total transmission power of all cell groups with a UCI-only transmission on a PUSCH of the first cell group does not exceed the maximum allowed transmission power of the UE.

If the total scheduled transmission power of the cell groups exceeds the maximum allowed transmission power of the UE, and if UCI is carried on a PUSCH transmission for a first cell group, then the eNB may receive a channel with a higher priority in one cell group when a total transmission power with a UCI-only transmission on a PUSCH of the first cell group exceeds the maximum allowed transmission power of the UE. The channel of the other cell group is dropped or power scaled.

If the total scheduled transmission power of the cell groups exceeds the maximum allowed transmission power of the UE, and if UCI is carried on a PUSCH transmission for a first cell group, then the eNB may receive the UCI on a PUCCH of the first cell group when a total transmission power of all cell groups with UCI on a PUCCH of the first cell group does not exceed the maximum allowed transmission power of the UE. The PUSCH transmission of the first cell group may be dropped.

If the total scheduled transmission power of the cell groups exceeds the maximum allowed transmission power of the UE, and if UCI is carried on a PUSCH transmission for a first cell group, then the eNB may receive the channel with a higher priority in one cell group when a total transmission power of all cell groups with UCI on a PUCCH of the first cell group exceeds the maximum allowed transmission power of the UE. The channel of the other cell group may be dropped or power scaled.

If the total scheduled transmission power of the cell groups exceeds the maximum allowed transmission power of the UE, and if UCI is carried on a PUSCH transmission for an SCG, then the eNB may receive the UCI only on the PUSCH of the SCG when a total transmission power of all cell groups with a UCI-only transmission on a PUSCH of the SCG does not exceed the maximum allowed transmission power of the UE.

If the total scheduled transmission power of the cell groups exceeds the maximum allowed transmission power of the UE, and if UCI is carried on a PUSCH transmission for an SCG, then the eNB may receive the UCI on a PUCCH of the SCG instead of the PUSCH of the SCG when a total transmission power of all cell groups with the UCI on the PUCCH of the SCG instead of the PUSCH of the SCG does not exceed the maximum allowed transmission power of the UE. The PUSCH transmission of the SCG may be dropped.

A method for dual-connectivity operation by a UE is also described. The method includes determining that dual-connectivity is configured with more than one cell group. The method also includes determining if a total scheduled transmission power of the cell groups exceeds a maximum allowed transmission power of the UE. The method further includes determining a priority of UCI types and channel types among the cell groups. The method additionally includes determining if UCI is carried on a PUSCH transmission for a cell group. The method also includes determining if total transmission power of all cell groups with UCI-only transmissions exceeds the maximum allowed transmission power of the UE. The method further includes transmitting UCI and channels on the cell groups.

A method for dual-connectivity operation by an eNB is also described. The method includes determining that dual-connectivity is configured with more than one cell group. The method also includes receiving UCI and channels on a cell group. The receiving is based on different assumptions of: whether a total scheduled transmission power of the cell groups exceeds a maximum allowed transmission power of a UE; a priority of UCI types and channel types among the cell groups; whether UCI is carried on a PUSCH transmission for a cell group; and whether a total transmission power of all cell groups with UCI-only transmissions exceeds the maximum allowed transmission power of the UE.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an eNB, a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, one example of a “base station” is an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall descriptions, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may consist of a primary cell and/or zero, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The systems and methods disclosed herein describe devices for dual-connectivity operation. This may be done in the context of an evolved universal terrestrial radio access network (E-UTRAN). For example, dual-connectivity operation between a user equipment (UE) and two or more eNBs on an E-UTRAN is described. In one configuration, the two or more eNBs may have different schedulers.

The systems and methods described herein may enhance the efficient use of radio resources in dual-connectivity operation. Carrier aggregation refers to the concurrent utilization of more than one component carrier (CC). In carrier aggregation, more than one cell may be aggregated to a UE. In one example, carrier aggregation may be used to increase the effective bandwidth available to a UE. In traditional carrier aggregation, a single eNB is assumed to provide multiple serving cells for a UE. Even in scenarios where two or more cells may be aggregated (e.g., a macro cell aggregated with remote radio head (RRH) cells) the cells may be controlled (e.g., scheduled) by a single eNB.

However, in a small cell deployment scenario, each node (e.g., eNB, RRH, etc.) may have its own independent scheduler. To maximize the efficiency of radio resources utilization of both nodes, a UE may connect to two or more nodes that have different schedulers.

In one configuration, for a UE to connect to two nodes (e.g., eNBs) that have different schedulers, dual-connectivity between the UE and E-UTRAN may be utilized. For example, in addition to Rel-11 operation, a UE operating according to the Rel-12 standard may be configured with dual-connectivity (which may also be referred to as multi-connectivity, inter-eNB carrier aggregation, multi-flow, multi-cell cluster, multi-Uu, etc.). Because a maximum of two connections are currently considered, terminology of “dual-connectivity” may be used. The UE may connect to the E-UTRAN with multiple Uu interfaces, if configured. For instance, the UE may be configured to establish one or more additional radio interfaces by using one radio interface. Hereafter, one node is referred to as master eNB (MeNB) and another node is referred to as secondary eNB (SeNB).

Dual-connectivity may provide an enhancement for small cell deployment. One of the key issues associated with dual-connectivity is the uplink power control for simultaneous uplink channel transmissions. In a power unlimited case, the uplink channel on each cell group should be transmitted using existing power control parameters and procedures. As used herein, the power unlimited case means that the total scheduled transmission power of uplink signals on all cell groups does not exceed the maximum allowed transmission power (i.e. Pcmax), of the given UE. However, in a power limited case, where the total scheduled uplink transmission powers on a master cell group (MCG) and a secondary cell group (SCG) exceed the maximum allowed transmission power of the UE (Pcmax), the UE has to perform uplink channel prioritization and power scaling on one or both uplink channels so that the total transmission power is within the power limit.

For dual-connectivity, both synchronized and non-synchronized networks may be supported. Separate uplink control information (UCI) reporting may be performed on each cell group. Hybrid automatic repeat request acknowledgement/negative acknowledgement (HARQ-ACK) and channel state information (CSI) related to the MCG may be transmitted to the MeNB only. UCI related to the PDSCH/PUSCH operation in the SCG may be transmitted to the SeNB only. For example, the HARQ-ACK for the PDSCH of the SCG cells and/or periodic and aperiodic CSI of the SCG cells may be transmitted to the SeNB only.

In an SCG, the UCI transmission rules as in Rel-11 may be supported, with the primary cell (PCell) replaced by the primary secondary cell (PSCell). The UCI transmission rules may include the physical channel (physical uplink control channel (PUCCH) or PUSCH) in which UCI is transmitted; selection of the cell in which UCI is transmitted in the case of UCI on PUSCH; selection of PUCCH resources for HARQ-ACK; periodic CSI dropping rules; handling of UCI combinations; and HARQ-ACK timing and multiplexing.

The MCG serving cells may carry signaling radio bearers (SRBs) and are, therefore, essential for maintaining the connection toward the UE. The preamble transmission in the PCell is considered more important than the preamble transmission in any other cell. Therefore, in the case of dual-connectivity, a UE may give higher priority to a PUSCH transmission on the MCG than a PUCCH transmission on the SCG.

The described systems and methods evaluate the total power based on PUCCH and/or PUSCH information. Various conditions and orders of power allocation are described for different scenarios. The described systems and methods may utilize legacy behaviors in most cases to minimize potential specification impacts while facilitating the new requirements of dual-connectivity.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

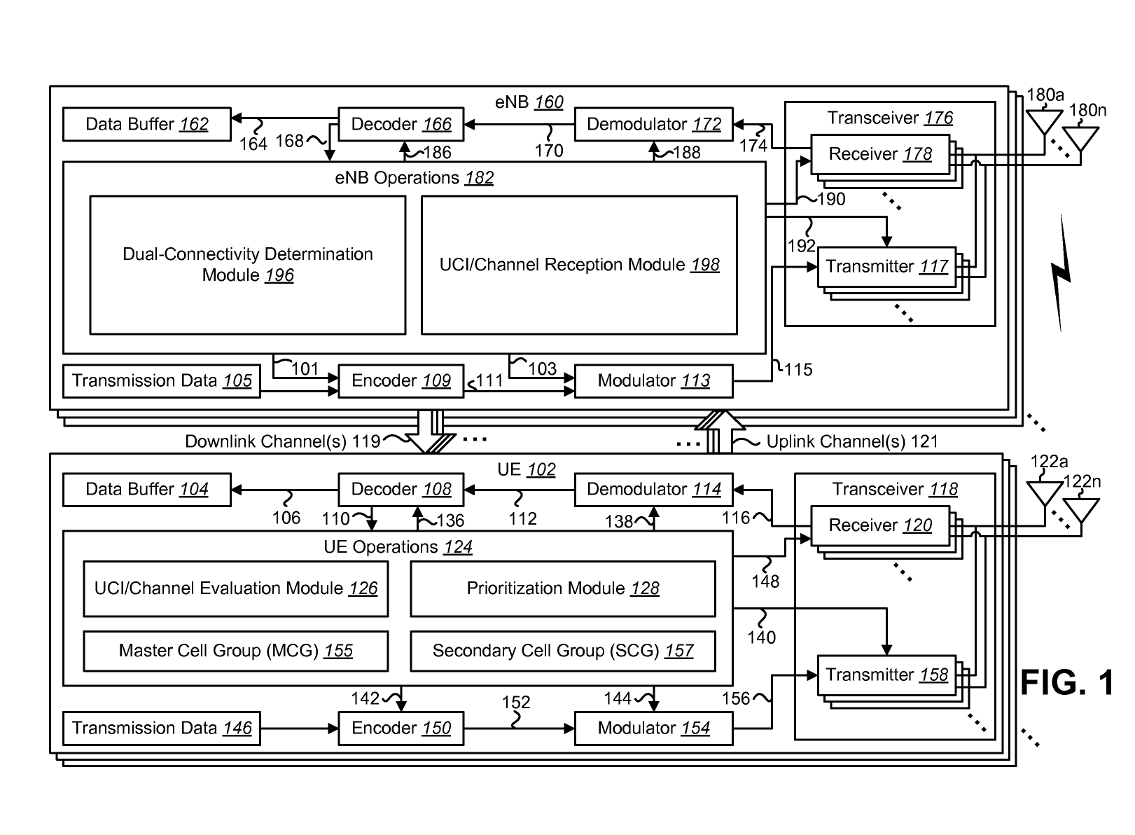

FIG. 1 is a block diagram illustrating one configuration of one or more evolved Node Bs (eNBs) 160 and one or more user equipments (UEs) 102 in which systems and methods for dual-connectivity operation may be implemented. The one or more UEs 102 may communicate with one or more eNBs 160 using one or more antennas 122a-n. For example, a UE 102 transmits electromagnetic signals to the eNB 160 and receives electromagnetic signals from the eNB 160 using the one or more antennas 122a-n. The eNB 160 communicates with the UE 102 using one or more antennas 180a-n.

It should be noted that in some configurations, one or more of the UEs 102 described herein may be implemented in a single device. For example, multiple UEs 102 may be combined into a single device in some implementations. Additionally or alternatively, in some configurations, one or more of the eNBs 160 described herein may be implemented in a single device. For example, multiple eNBs 160 may be combined into a single device in some implementations. In the context of FIG. 1, for instance, a single device may include one or more UEs 102 in accordance with the systems and methods described herein. Additionally or alternatively, one or more eNBs 160 in accordance with the systems and methods described herein may be implemented as a single device or multiple devices.

The UE 102 and the eNB 160 may use one or more channels 119, 121 to communicate with each other. For example, a UE 102 may transmit information or data to the eNB 160 using one or more uplink channels 121 and signals. Examples of uplink channels 121 include a physical uplink control channel (PUCCH) and a physical uplink shared channel (PUSCH), etc. Examples of uplink signals include a demodulation reference signal (DMRS) and a sounding reference signal (SRS), etc. The one or more eNBs 160 may also transmit information or data to the one or more UEs 102 using one or more downlink channels 119 and signals, for instance. Examples of downlink channels 119 include a PDCCH, a PDSCH, etc. Examples of downlink signals include a primary synchronization signal (PSS), a cell-specific reference signal (CRS), and a channel state information (CSI) reference signal (CSI-RS), etc. Other kinds of channels or signals may be used.

Each of the one or more UEs 102 may include one or more transceivers 118, one or more demodulators 114, one or more decoders 108, one or more encoders 150, one or more modulators 154, one or more data buffers 104 and one or more UE operations modules 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the eNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the eNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more eNBs 160. The UE operations module 124 may include one or more of a UCI/channel evaluation module 126 and a prioritization module 128.

The UE operations module 124 may provide the benefit of utilizing the radio resources of an MCG 155 and an SCG 157 efficiently. When an SCG 157 is added, the two cell groups may be configured. One cell group is an MCG 155 and another is an SCG 157. An MCG 155 may provide a signaling radio bearer (SRB) to exchange an RRC message. An SCG 157 may be added via the MCG 155. The MCG 155 may provide a radio connection between the UE 102 and a master eNB (MeNB) 160. The SCG 157 may provide a radio connection between the UE 102 and a secondary eNB (SeNB) 160.

The UCI/channel evaluation module 126 may determine if a total scheduled transmission power of the cell groups (e.g., MCG 155 and SCG 157) exceeds a maximum allowed transmission power of the UE 102 (Pcmax). If the total scheduled transmission power of the cell groups does not exceed the maximum allowed transmission power of the UE 102, then the UE 102 is in a power unlimited case. In this case, simultaneous uplink transmission from the MCG 155 and the SCG 157 should be performed independently.

If the total scheduled transmission power of the cell groups exceeds the maximum allowed transmission power of the UE 102, then the UE 102 is in a power limited case. In this case, because the total uplink transmission powers on the MCG 155 and the SCG 157 exceeds Pcmax, the UE 102 may perform uplink channel prioritization and power scaling on one or both uplink channels 121 so that the total transmission power is within the power limit.

The UCI/channel evaluation module 126 may determine if UCI is carried on a PUSCH transmission for a cell group. For PUSCH transmissions, a PUSCH with UCI may be prioritized over a PUSCH without UCI. Therefore, in a power limited case, the PUSCH without UCI may be dropped or power scaled before the PUSCH with UCI within each cell group.

The UCI/channel evaluation module 126 may determine if the total transmission power of all cell groups with UCI-only transmissions exceeds the maximum allowed transmission power of the UE 102. In one configuration, the UCI/channel evaluation module 126 may assume a UCI-only transmission on a PUSCH. In other words, the UCI/channel evaluation module 126 may evaluate whether the total transmission power of all cell groups still exceeds the maximum allowed transmission power of the UE 102 by dropping the PUSCH without UCI, and dropping the data part on a PUSCH with UCI. If the total transmission power is less than the maximum allowed transmission power of the UE 102, the UCI/channel evaluation module 126 may transmit UCI on the PUSCH assuming a UCI-only PUSCH report. Further power scaling may be applied for the PUSCH data transmission.

If the total transmission power with UCI-only on PUSCH still exceeds the maximum allowed transmission power of the UE 102, the prioritization module 128 may use priority rules to determine channel dropping based on uplink channel type and UCI type. The prioritization module 128 may determine a priority of UCI types and channel types among the cell groups. Different physical uplink channels and UCI achieve different functions. Thus, different physical uplink channels and UCI have different importance to UE 102 operation.

In a power limited case, if the total uplink transmission powers on the MCG 155 and SCG 157 exceeds the maximum allowed transmission power of the UE 102, the UE 102 may perform uplink channel prioritization and power scaling on at least one uplink channel 121 so that the total power does not exceed Pcmax. An uplink channel 121 with the lower priority should be dropped or power scaled down before an uplink channel 121 with higher priority.

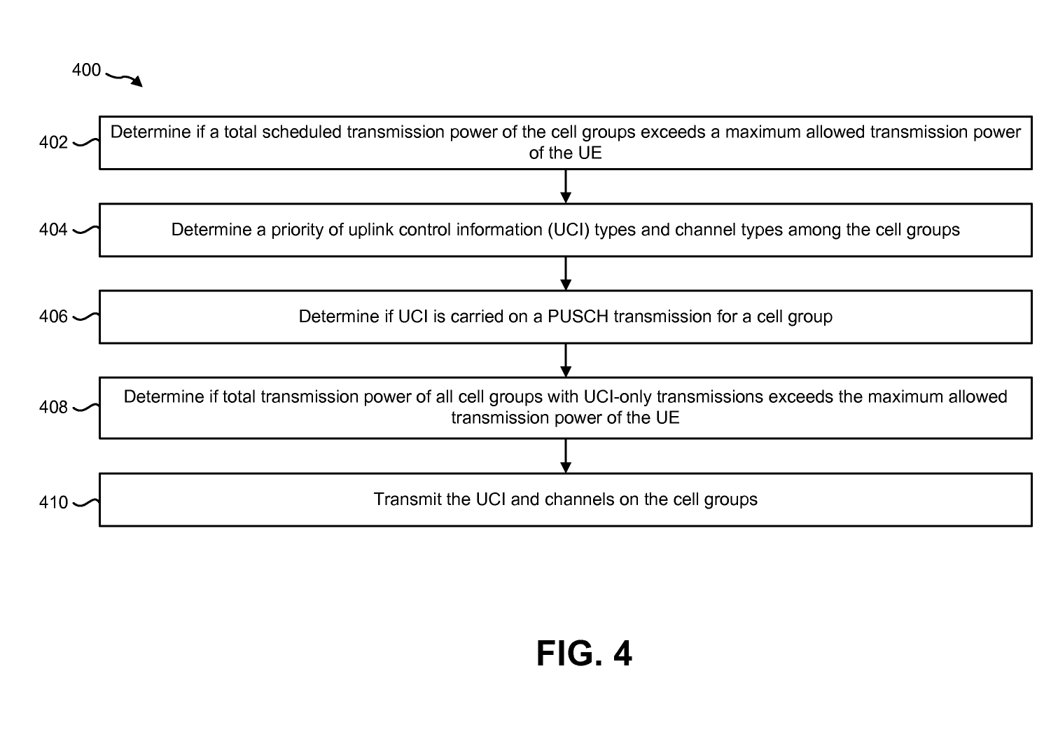

The prioritization module 128 may apply priority rules to determine whether to drop an uplink channel 121. This may be accomplished as described in connection with FIG. 4.

In a power limited case, for a PUSCH transmission without UCI, power scaling can be used to reduce the PUSCH transmission power so that the total transmission power is below Pcmax. In one configuration, the power scaling may be performed by a scaling factor that is less than 1 in all resource elements for the PUSCH transmission.

In one example, the higher priority signal transmitted on a cell group may be PUCCH if the higher priority signal is transmitted on the PUCCH. In another example, the higher priority signal transmitted on a cell group may be PUSCH if the higher priority signal is transmitted on a PUSCH with or without UCI. In yet another example, the higher priority signals transmitted on a cell group may be both PUCCH and PUSCH if the higher priority signals are transmitted simultaneously on PUCCH and PUSCH.

In a simple approach, if the UCI on the PUSCH transmission has lower priority, the PUSCH with UCI should be dropped. If the UCI on the PUSCH transmission has higher priority than the uplink channel 121 of the other cell group, the PUSCH with UCI on the given cell group should be transmitted.

In another configuration, the UCI/channel evaluation module 126 may assume a UCI transmission on a PUCCH. A PUSCH with data transmission normally requires more power than a PUCCH transmission. Therefore, as an alternative to evaluating UCI on PUSCH-only transmissions, the UE 102 may evaluate the power to transmit UCI on PUCCH instead of PUSCH.

The UE operations module 124 may provide information 148 to the one or more receivers 120. The UE operations module 124 may also provide information 138 to the demodulator 114. For example, the UE operations module 124 may inform the demodulator 114 of a modulation pattern anticipated for transmissions from the eNB 160.

The UE operations module 124 may provide information 136 to the decoder 108. For example, the UE operations module 124 may inform the decoder 108 of an anticipated encoding for transmissions from the eNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include UCI and/or a channel (e.g., PUSCH or PUCCH) on the MCG 155 or SCG 157.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the eNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the eNB 160. The one or more transmitters 158 may upconvert and transmit the modulated signal(s) 156 to one or more eNBs 160.

The eNB 160 may include one or more transceivers 176, one or more demodulators 172, one or more decoders 166, one or more encoders 109, one or more modulators 113, one or more data buffers 162 and one or more eNB operations modules 182. For example, one or more reception and/or transmission paths may be implemented in an eNB 160. For convenience, only a single transceiver 176, decoder 166, demodulator 172, encoder 109 and modulator 113 are illustrated in the eNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The eNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PUSCH transmission data) that may be used by the eNB operations module 182 to perform one or more operations.

In general, the eNB operations module 182 may enable the eNB 160 to communicate with the one or more UEs 102. The eNB operations module 182 may include one or more of a dual-connectivity determination module 196 and a UCI/channel reception module 198. The eNB operations module 182 may provide the benefit of utilizing the radio resources of the MCG 155 and the SCG 157 efficiently.

If the eNB 160 supports dual-connectivity, the dual-connectivity determination module 196 may determine that dual-connectivity is configured with more than one cell group. For example, the eNB 160 may provide one cell group and another eNB 160 may provide a second cell group. The cell group may be an MCG 155 or an SCG 157.

The UCI/channel reception module 198 may receive UCI and channels on a cell group based on different assumptions of whether a total scheduled transmission power of the cell groups exceeds a maximum allowed transmission power of a UE 102. It should be noted that the eNB 160 of one cell group may not know the required transmission power of another cell group. If the total scheduled transmission power of the cell groups does not exceed the maximum allowed transmission power of the UE 102, then the UE 102 is in a power unlimited case. In this case, simultaneous uplink transmission from the MCG 155 and the SCG 157 should be performed independently by the UE 102. The eNB 160 may expect to receive the uplink channels on the cell group with the scheduled power.

If the total scheduled transmission power of the cell groups exceeds the maximum allowed transmission power of the UE 102, then the UE 102 is in a power limited case. In this case, if the total scheduled uplink transmission powers on the MCG 155 and the SCG 157 exceeds Pcmax, the UCI/channel reception module 198 may receive UCI and/or channels based on uplink channel prioritization and power scaling on one or both uplink channels 121 so that the total transmission power is within the power limit. An uplink channel 121 with the lower priority may be dropped or power scaled down before an uplink channel 121 with higher priority. The UCI/channel reception module 198 may receive the UCI and/or channels for a cell group based on the priority rules described in connection with FIG. 4. Thus, the eNB 160 may expect that some of the scheduled uplink transmissions or channels are dropped or are transmitted with reduced power. In other words, the eNB 160 may expect that some scheduled uplink transmissions or channels are dropped or not transmitted with the scheduled power.

The UCI/channel reception module 198 may also receive UCI and channels on a cell group based on whether UCI is scheduled to be carried on a PUSCH transmission for the cell group. For PUSCH transmissions, a PUSCH with UCI may be prioritized over a PUSCH without UCI. Therefore, in a power limited case, the eNB 160 may expect that the PUSCH without UCI may be dropped or power scaled before the PUSCH with UCI within each cell group.

The UCI/channel reception module 198 may further receive UCI and channels on a cell group based on different assumptions of whether a total transmission power of all cell groups with UCI-only transmissions exceeds the maximum allowed transmission power of the UE 102. In one configuration, if the total transmission power of all cell groups with a UCI-only transmission on a PUSCH is less than the maximum allowed transmission power of the UE 102, the UCI/channel reception module 198 may receive UCI on the PUSCH in a UCI-only PUSCH report. The eNB may expect further power scaling is applied for the PUSCH data transmission.

If the total transmission power with UCI-only on PUSCH still exceeds the maximum allowed transmission power of the UE 102, the UCI/channel reception module 198 may receive UCI and channels based on the priority rules described in connection with FIG. 4. The UCI and channel dropping may be based on uplink channel 121 type and UCI type. For example, if the UCI on the PUSCH transmission has lower priority, the PUSCH with UCI may be dropped. If the UCI on the PUSCH transmission has higher priority than the uplink channel 121 of the other cell group, the PUSCH with UCI on the given cell group may be received.

In another configuration, the UCI/channel reception module 198 may receive a UCI transmission on a PUCCH. As described above, PUSCH with data transmission normally requires more power than a PUCCH transmission. Therefore, as an alternative to receiving UCI on PUSCH-only transmissions, the eNB 160 may expect to receive UCI on a PUCCH transmission instead of a PUSCH transmission.

The eNB operations module 182 may provide information 190 to the one or more receivers 178. For example, the eNB operations module 182 may inform the receiver(s) 178 when or when not to receive transmissions based on the received UCI and channels.

The eNB operations module 182 may provide information 188 to the demodulator 172. For example, the eNB operations module 182 may inform the demodulator 172 of a modulation pattern anticipated for transmissions from the UE(s) 102.

The eNB operations module 182 may provide information 186 to the decoder 166. For example, the eNB operations module 182 may inform the decoder 166 of an anticipated encoding for transmissions from the UE(s) 102.

The eNB operations module 182 may provide information 101 to the encoder 109. The information 101 may include data to be encoded and/or instructions for encoding. For example, the eNB operations module 182 may instruct the encoder 109 to encode transmission data 105 and/or other information 101.

In general, the eNB operations module 182 may enable the eNB 160 to communicate with one or more network nodes (e.g., a mobility management entity (MME), serving gateway (S-GW), eNBs). The eNB operations module 182 may also generate a RRC connection reconfiguration message to be signaled to the UE 102. The RRC connection reconfiguration message may or may not include SCG configuration parameters for SCG 157 addition modification. The eNB operations module 182 may send, to the other eNB 160, the RRC connection reconfiguration message to be signaled to the UE 102. For example, the other eNB 160 may receive the SCG configuration parameters for SCG 157 addition or modification from the eNB 160 as a container. The eNB 160 may generate a RRC connection reconfiguration message that may include the received container and may send the RRC connection reconfiguration message to the UE 102. The eNB 160 may just send a RRC connection reconfiguration message included in the received container.

The encoder 109 may encode transmission data 105 and/or other information 101 provided by the eNB operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The eNB operations module 182 may provide information 103 to the modulator 113. This information 103 may include instructions for the modulator 113. For example, the eNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The eNB operations module 182 may provide information 192 to the one or more transmitters 117. This information 192 may include instructions for the one or more transmitters 117. For example, the eNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

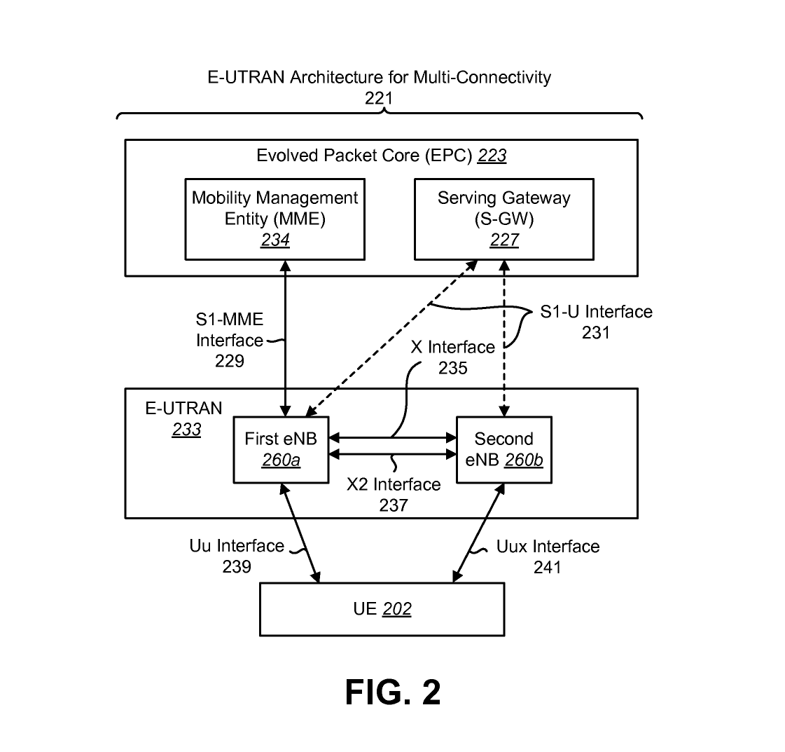

FIG. 2 is a block diagram illustrating configurations of E-UTRAN architecture 221 in which systems and methods for dual-connectivity operation may be implemented. The UE 202 described in connection with FIG. 2 may be implemented in accordance with the UE 102 described in connection with FIG. 1. The eNBs 260a-b described in connection with FIG. 2 may be implemented in accordance with the eNB 160 described in connection with FIG. 1.

The E-UTRAN architecture for multi-connectivity 221 is one example of E-UTRAN architecture that may provide dual-connectivity for a UE 202. In this configuration, the UE 202 may connect to E-UTRAN 233 via a Uu interface 239 and a Uux interface 241. The E-UTRAN 233 may include a first eNB 260a and a second eNB 260b. The eNBs 260a-b may provide the E-UTRA user plane (PDCP/RLC/MAC/PHY) and control plane (RRC) protocol terminations toward the UE 202. The eNBs 260a-b may be interconnected with each other by an X2 interface 237. The S1 interfaces 229, 231 may support a many-to-many relation between MMEs 234, serving gateways 227 and eNBs 260a-b. The first eNB (e.g., MeNB) 260a and the second eNB (e.g., SeNB) 260b may also be interconnected with each other by means of one or more X interfaces 235, which may or may not be the same as the S1-MME 229 and/or X2 interface 237.

The eNBs 260 may host a variety of functions. For example, the eNBs 260 may host functions for radio resource management (e.g., radio bearer control, radio admission control, connection mobility control, dynamic allocation of resources to UEs 202 in both uplink and downlink (scheduling)). The eNBs 260 may also perform IP header compression and encryption of user data stream; selection of an MME 234 at UE 202 attachment when no routing to an MME 234 can be determined from the information provided by the UE 202; and routing of user plane data toward the serving gateway 227. The eNBs 260 may additionally perform scheduling and transmission of paging messages (originated from the MME 234); scheduling and transmission of broadcast information (originated from the MME or operation and maintenance (O&M)); measurement and measurement reporting configuration for mobility and scheduling; and scheduling and transmission of the public warning system (PWS) (which may include the earthquake and tsunami warning system (ETWS) and commercial mobile alert system (CMAS)) messages (originated from the MME 234). The eNBs 260 may further perform closed subscriber group (CSG) handling and transport level packet marking in the uplink.

The MME 234 may host a variety of functions. For example, the MME 234 may perform Non-Access Stratum (NAS) signaling; NAS signaling security; access stratum (AS) security control; inter core network (CN) node signaling for mobility between 3GPP access networks; and idle mode UE Reachability (including control and execution of paging retransmission). The MME 234 may also perform tracking area list management (for a UE 202 in idle and active mode); packet data network gateway (PDN GW) and S-GW selection; MME 234 selection for handovers with MME 234 change; and Serving GPRS Support Node (SGSN) selection for handovers to 2G or 3G 3GPP access networks. The MME 234 may additionally host roaming, authentication, and bearer management functions (including dedicated bearer establishment). The MME 234 may provide support for PWS (which includes ETWS and CMAS) message transmission, and may optionally perform paging optimization.

The S-GW 227 may also host the following functions. The S-GW 227 may host the local mobility anchor point for inter-eNB 260 handover. The S-GW 227 may perform mobility anchoring for inter-3GPP mobility; E-UTRAN idle mode downlink packet buffering and initiation of network triggered service request procedure; lawful interception; and packet routing and forwarding. The S-GW 227 may also perform transport level packet marking in the uplink and the downlink; accounting on user and QoS Class Identifier (QCI) granularity for inter-operator charging; and uplink (UL) and downlink (DL) charging per UE 202, packet data network (PDN), and QCI.

The radio protocol architecture of E-UTRAN 233 may include the user plane and the control plane. The user plane protocol stack may include PDCP, RLC, MAC and PHY sublayers. The PDCP, RLC, MAC and PHY sublayers (terminated at the eNB 260a on the network) may perform functions (e.g., header compression, ciphering, scheduling, ARQ and HARQ) for the user plane. PDCP entities are located in the PDCP sublayer. RLC entities are located in the RLC sublayer. MAC entities are located in the MAC sublayer. The PHY entities are located in the PHY sublayer.

The control plane may include a control plane protocol stack. The PDCP sublayer (terminated in eNB 260a on the network side) may perform functions (e.g., ciphering and integrity protection) for the control plane. The RLC and MAC sublayers (terminated in eNB on the network side) may perform the same functions as for the user plane. The RRC (terminated in eNB 260a on the network side) may perform the following functions. The RRC may perform broadcast functions, paging, RRC connection management, radio bearer (RB) control, mobility functions, UE 202 measurement reporting and control. The NAS control protocol (terminated in MME 234 on the network side) may perform, among other things, evolved packet system (EPS) bearer management, authentication, evolved packet system connection management (ECM)-IDLE mobility handling, paging origination in ECM-IDLE and security control.

The first eNB 260a and the second eNB 260b may be connected by the S1 interfaces 229, 231 to the EPC 223. The first eNB 260a may be connected to the MME 234 by the S1-MME interface 229. In one configuration, the second eNB 260b may be connected to the serving gateway 227 by the S1-U interface 231 (as indicated by a dashed line). The first eNB 260a may behave as the MME 234 for the second eNB 260b so that S1-MME interface 229 for the second eNB 260b may be connected (via the X interface 235, for instance) between the first eNB 260a and the second eNB 260b. Therefore, the first eNB 260a may appear to the second eNB 260b as an MME 234 (based on the S1-MME interface 229) and an eNB 260 (based on the X2 interface 237).

In another configuration, first eNB 260a may also be connected to the serving gateway 227 by the S1-U interface 231 (as indicated by a dashed line). Therefore, the second eNB 260b may not be connected to the EPC 223. The first eNB 260a may appear to the second eNB 260b as an MME 234 (based on the S1-MME interface 229), an eNB (based on the X2 interface 237), and an S-GW 227 (based on the S1-U interface 231). This architecture 221 may provide a single node S1 interface 229, 231 (e.g., connection) with the EPC 223 for the first eNB 260a and the second eNB 260b. By the single node connection with EPC 223, MME 234 S-GW 227, a change (e.g., handover) could be mitigated as long as the UE 202 is in the coverage of the first eNB 260a.

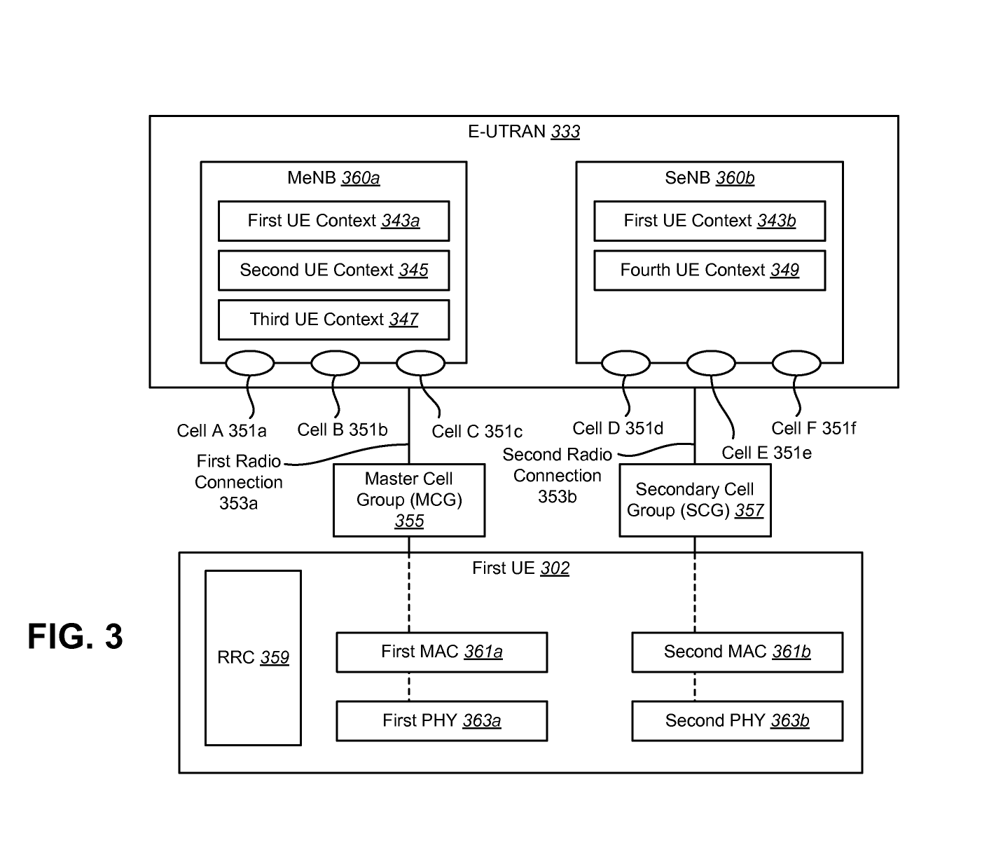

FIG. 3 is a block diagram illustrating one configuration of an E-UTRAN 333 and a UE 302 in which systems and methods for dual-connectivity operation may be implemented. The UE 302 and the E-UTRAN 333 described in connection with FIG. 3 may be implemented in accordance with corresponding elements described in connection with at least one of FIGS. 1 and 2.

In traditional carrier aggregation, a single eNB 360 is assumed to provide multiple serving cells 351 for a UE 302. Even in scenarios where two or more cells 351 may be aggregated (e.g., a macro cell aggregated with remote radio head (RRH) cells 351), the cells 351 may be controlled (e.g., scheduled) by a single eNB 360. However, in a small cell deployment scenario, each eNB 360 (e.g., node) may have its own independent scheduler. To utilize radio resources of both eNBs 360a-b, the UE 302 may connect to both eNBs 360a-b.

When carrier aggregation is configured, the UE 302 may have one RRC connection with the network. A radio interface may provide carrier aggregation. During RRC connection establishment, re-establishment and handover, one serving cell 351 may provide NAS mobility information (e.g., a tracking area identity (TAI)). During RRC connection re-establishment and handover, one serving cell 351 may provide a security input. This cell 351 may be referred to as the primary cell (PCell). In the downlink, the component carrier corresponding to the PCell may be the downlink primary component carrier (DL PCC), while in the uplink it may be the uplink primary component carrier (UL PCC).

Depending on UE 302 capabilities, one or more SCells may be configured to form together with the PCell a set of serving cells 351a-f. In the downlink, the component carrier corresponding to a SCell may be a downlink secondary component carrier (DL SCC), while in the uplink it may be an uplink secondary component carrier (UL SCC).

The configured set of serving cells 351a-f for the UE 302, therefore, may consist of one PCell and one or more SCells. For each SCell, the usage of uplink resources by the UE 302 (in addition to the downlink resources) may be configurable. The number of DL SCCs configured may be larger than or equal to the number of UL SCCs and no SCell may be configured for usage of uplink resources only.

From a UE 302 viewpoint, each uplink resource may belong to one serving cell 351. The number of serving cells 351 that may be configured depends on the aggregation capability of the UE 302. The PCell may only be changed using a handover procedure (e.g., with a security key change and a random access channel (RACH) procedure). The PCell may be used for transmission of the PUCCH. Unlike the SCells, the PCell may not be de-activated. Re-establishment may be triggered when the PCell experiences radio link failure (RLF), not when the SCells experience RLF. Furthermore, NAS information may be taken from the PCell.

The reconfiguration, addition and removal of SCells may be performed by an RRC 359. At intra-LTE handover, RRC 359 may also add, remove or reconfigure SCells for usage with a target PCell. When adding a new SCell, dedicated RRC signaling may be used for sending all required system information of the SCell (e.g., while in connected mode, UEs 302 need not acquire broadcasted system information directly from the SCells).

However, to connect to both eNBs 360 that have different schedulers, dual-connectivity between the UE 302 and E-UTRAN 333 may be required. In addition to Release-11 operation, a UE 302 operating according to Release-12 may be configured with dual-connectivity (which may also be called multi-connectivity, inter-node carrier aggregation, inter-node radio aggregation, multi-flow, multi-cell cluster, multi-Uu, etc.).

The UE 302 may connect to E-UTRAN 333 with multiple Uu interfaces 239, 241, if configured. For example, a UE 302 may be configured to establish an additional radio interface (e.g., radio connection 353) by using one radio interface (radio connection 353). Hereafter, one eNB 360 is referred to as a master eNB (MeNB) 360a, which may also be called a primary eNB (PeNB). Another eNB 360 is referred to as s secondary eNB (SeNB) 360b. The Uu interface 239 (which may be called primary Uu interface) is a radio interface between the UE 302 and the MeNB 360a. The Uux interface 241 (which may be called secondary Uu interface) is a radio interface between the UE 302 and the SeNB 360b.

In one configuration, the UE 302 may not be required to be aware of the MeNB 360a and SeNB 260b as long as the UE 302 is aware of multiple Uu interfaces 239, 241 (i.e., MCG 355 and SCG 357) with the E-UTRAN 333. Also, the E-UTRAN 333 may provide multiple Uu interfaces with the same or different eNBs 360.

In one configuration, the MeNB 360a and SeNB 360b could be the same eNB 360. The multiple Uu interfaces 239, 241 (e.g., dual-connectivity) can be achieved even by a single eNB 360. The UE 302 may be able to connect more than one Uux interface 241 (e.g., Uu1, Uu2, Uu3 . . . ). Each Uu interface 239, 241 can have carrier aggregation. Therefore, the UE 302 may be configured with more than one set of serving cells 351 in case of CA. In dual connectivity (i.e, two sets), one set of serving cells 351 may be the MCG 355, another set of serving cells may be the SCG 357.

Multiple Uu interfaces 239, 241 are described herein, but this functionality could be realized by a single Uu interface 239 depending on the definition of Uu interface 239. Dual-connectivity may be realized by a single Uu interface 239 or a single radio interface depending on the definition of the interface. A radio interface can be defined as an interface between a UE 302 and the E-UTRAN 333, but not an interface between the UE 302 and an eNB 360. For example, one radio interface can be defined as an interface between a UE 302 and the E-UTRAN 333 with dual-connectivity. Therefore, the difference between the Uu 239 and Uux 241 above may be considered as a characteristic of cells 351. The Uu interface 239 and the Uux interface 241 may be rephrased by a set A of cell(s) and a set B of cell(s), respectively. Also, a radio interface and an additional radio interface can be rephrased by a master cell group (MCG) 355 and secondary cell group (SCG) 357, respectively.

In some implementations, the E-UTRAN 333 may include a MeNB 360a and a SeNB 360b. The UE 302 may communicate with the MeNB 360a via a first radio connection 353a. The UE 302 may communicate with the SeNB 360b via the second radio connection 353b. While FIG. 3 depicts one first radio connection 353a and one second radio connection 353b, the UE 302 may be configured with one first radio connection 353a and one or more second radio connections 353b. The MeNB 360a and SeNB 360b may be implemented in accordance with the eNB 160 described in connection with FIG. 1.

The MeNB 360a may provide multiple cells 351a-c for connection to one or more UEs 302. For example, the MeNB 360a may provide cell A 351a, cell B 351b and cell C 351c. Similarly, the SeNB 360b may provide multiple cells 351d-f. The UE 302 may be configured to transmit/receive on one or more cells (e.g., cell A 351a, cell B 351b and cell C 351c) for the first radio connection 353a (e.g., a master cell group (MCG) 355). The UE 302 may also be configured to transmit/receive on one or more other cells (e.g., cell D 351d, cell E 351e and cell F 351f) for the second radio connection 353b (e.g., a secondary cell group (SCG) 357).

The MCG 355 may contain one PCell and one or more optional SCell(s). The SCG 357 may contain one PCell-like cell (that may be called PCell, primary SCell (PSCell), secondary PCell (SPCell), PCellscg, SCG PCell, etc.) and one or more optional SCell(s). If the UE 302 is configured to transmit/receive on multiple cells 351a-f for a radio connection 353a-b, a carrier aggregation operation may be applied to the radio connection 353a-b. In one configuration, each radio connection 353 may be configured with a primary cell and no, one, or more secondary cell(s). In another configuration, at least one radio connection 353 may be configured with a primary cell and no, one, or more secondary cell(s) and the other radio connections 353 may be configured with one or more secondary cell(s). In yet another configuration, at least one radio connection 353 may be configured with a primary cell and no, one, or more secondary cell(s) and the other radio connections 353 may be configured with a PCell-like cell and no, one or more secondary cell(s).

One MAC entity 361 and one PHY entity 363 may be mapped to one cell group. For example, a first MAC entity 361a and a first PHY entity 363a may be mapped to the MCG 355. Similarly, a second MAC entity 361b and a second PHY entity 363b may be mapped to the SCG 357. The UE 302 may be configured with one MCG 355 (e.g., the first radio connection 353a) and optionally one or more SCG(s) 357 (e.g., the second connection 353b).

The MeNB 360a manages and stores UE contexts for the first radio connection 353a. The UE contexts may be RRC contexts (e.g., configurations, configured cells 351, security information, etc.), QoS information and UE 302 identities for each UE 302 for configured cells 351 for the UE 302. For example, the MeNB 360a may manage and store a first UE context 343a, a second UE context 345 and a third UE context 347.

The SeNB 360b manages and stores UE contexts for the second radio connection 353b for each UE 302 for configured cells 351 for the UE 302. For example, the SeNB 360b may manages and store the first UE context 343b and a fourth UE context 349. An eNB 360 can behave as both MeNB 360a and SeNB 360b. Therefore, the eNB 360 may manage and store UE contexts for UEs 302 connected to a first radio connection 353a and UE contexts for UEs 302 connected to a second radio connection 353b.

In some implementations, the MAC entities 361a-b may have an interface with an RRC entity 359. The RRC entity 359 may receive RRC messages (e.g., RRC connection reconfiguration message, connection control message, handover command, etc.) from a RRC entity (not shown) of the E-UTRAN 333. The RRC entity 359 may also transmit RRC messages (e.g. RRC connection reconfiguration complete message) to the RRC entity (not shown) of the E-UTRAN 333.

FIG. 4 is a flow diagram illustrating one implementation of a method 400 for dual-connectivity operation by a UE 102. In dual-connectivity, a UE 102 may be connected to one or more cell groups. If the UE 102 supports dual-connectivity, the UE 102 may determine that dual-connectivity is configured with more than one cell group. For example, the UE 102 may be connected to an MCG 155 and an SCG 157.

For the uplink transmissions in a subframe, the UE 102 may determine 402 if a total scheduled transmission power of the cell groups exceeds a maximum allowed transmission power of the UE 102 (Pcmax). If the total scheduled transmission power of the cell groups does not exceed the maximum allowed transmission power of the UE 102, then the UE 102 is in a power unlimited case. In this case, simultaneous uplink transmission from the MCG 155 and the SCG 157 should be performed independently according to scheduled uplink transmission powers and existing priority rules within each cell group.

The physical uplink channels 121 may include a physical random access channel (PRACH) that is used for initial access on a cell. The PRACH may have the highest priority since it is normally the first uplink signal to be transmitted on a cell. If a PRACH is transmitted, the power of a PRACH should not be reduced for simultaneous transmission in a power limited case.

The uplink control information (UCI) is feedback control information from the UE 102. The UCI may include one or more of a scheduling request (SR), HARQ-ACK and channel state information (CSI).

The SR is a signal that may be used for channel access. The SR may have a higher priority than other UCI and channels except for the PRACH, which is not used when an SR resource is available.

HARQ-ACK for PDSCH transmission is used to feedback whether a previous PDSCH is correctly received or not by the UE 102. The CSI is the feedback on the downlink channel conditions so that the eNB 160 can schedule the data transmission more efficiently. The types of CSI may include a rank indication (RI), a precoding matrix indication (PMI) and/or a channel quality indicator (CQI), where CQI may be a wideband CQI and/or a narrow-band CQI. A CSI report may be a periodic CSI or an aperiod CSI.

A sounding reference signal (SRS) is a signal transmitted on the uplink. The eNB 160 may utilize the SRS to better estimate the uplink channel 121 conditions.

The PUCCH may be used to carry only UCI. The PUSCH can be used to carry data, and UCI can be multiplexed with data on the PUSCH. In the case where a PUSCH is scheduled by the eNB 160 and there is no data to be transmitted, UCI only may be reported on the PUSCH.

In any portion of a subframe, if the total scheduled transmission power of the cell groups exceeds the maximum allowed transmission power of the UE 102, then the UE 102 is in a power limited case. In this case, if the total scheduled uplink transmission powers on the MCG 155 and the SCG 157 exceeds the maximum allowed transmission power of the UE 102, the UE 102 may perform uplink channel prioritization and power scaling on one or both uplink channels 121 so that the total transmission power is within the power limit.

The UE 102 may determine 404 a priority of UCI types and channel types among the cell groups. Different physical uplink channels 121 and UCI achieve different functions. Thus, different physical uplink channels 121 and UCI have different importance to UE 102 operation.

In a power limited case, if the total uplink transmission powers on the MCG 155 and SCG 157 exceeds the maximum allowed transmission power of the UE 102, the UE 102 may perform uplink channel prioritization and power scaling on at least one uplink channel 121 so that the total power does not exceed the maximum allowed transmission power of the UE 102. An uplink channel 121 with the lower priority should be dropped or power scaled down before an uplink channel 121 with higher priority.

In general, the following priority rules and principles may be applied. These priority rules may also be referred to as dropping rules or channel dropping rules. For the same type of uplink channels 121 or UCI types, the uplink channel 121 on the MCG 155 has higher priority than the uplink channel 121 on the SCG 157 because the MCG 155 is normally used to provide mobility, RRC functionalities and voice services such as SPS transmissions.

Within a cell group, a priority order from high to low of different uplink channels 121 and can be defined as: PRACH, SR, HARQ-ACK, CSI, PUSCH without UCI and SRS.

For the CSI transmission on PUCCH or PUSCH, the same handling of UCI combinations can be used as in Rel-11/12. For example, with the priority order from high to low for RI, PMI, wideband CQI, narrow-band CQI, etc. Aperiodic CSI should have higher priority than periodic CSI since it is requested by the eNB 160 explicitly and normally contains more CSI content and payload size. A PUSCH transmission scheduled by SPS should have higher priority than a PUSCH transmission scheduled by PDCCH or enhanced PDCCH (EPDCCH).

With dual-connectivity, simultaneous PUCCH transmission on MCG 155 and SCG 157 needs to be supported. The information that may be carried on a PUCCH includes the following: SR on format 1a/1b or format 2 or format 3; HARQ-ACK on format 1a/1b or format 2 or format 3; and Periodic CSI on format 2 or format 3.

Reducing the transmission power by scaling on a PUCCH should be avoided because it may cause error detection of important UCI. Therefore, by applying the priority rule in a power limited scenario, only one PUCCH should be transmitted on either the MCG 155 or the SCG 157.

In one configuration, the PUCCH transmission dropping between two cell groups is based on the UCI type. The PUCCH transmission dropping between two cell groups may be defined according to the following priority rule: MCG with SR>SCG with SR>MCG with HARQ-ACK>SCG with HARQ-ACK>MCG with periodic RI>SCG with periodic RI>MCG with periodic PMI>SCG with periodic PMI>MCG with periodic wideband CQI>SCG with periodic wideband CQI>MCG with periodic narrowband CQI>SCG with periodic narrowband CQI. In this configuration, a PUCCH transmission with a lower priority may be dropped before a PUCCH transmission with a higher priority.

In another configuration, the MCG 155 is always protected with a higher priority. In other words, uplink transmissions associated with the MCG 155 may have higher priority than uplink transmissions associated with the SCG 157. In this configuration, the PUCCH transmission dropping between two cell groups may be defined according to the following priority rule: MCG with SR>MCG with HARQ-ACK>MCG with periodic RI>MCG with periodic PMI>MCG with periodic wideband CQI>MCG with periodic narrowband CQI>SCG with SR>SCG with HARQ-ACK>SCG with periodic RI>SCG with periodic PMI>SCG with periodic wideband CQI>SCG with periodic narrowband CQI. As above, in this configuration, a PUCCH transmission with a lower priority may be dropped before a PUCCH transmission with a higher priority. With this configuration, the dropping probability of SCG 157 is significantly increased, and may cause undesirable performance loss.

In a power limited case, for a PUSCH transmission without UCI, power scaling can be used to reduce the PUSCH transmission power so that the total transmission power is below the maximum allowed transmission power of the UE 102. In one configuration, the power scaling may be performed by a scaling factor that is less than 1 in all resource elements for the PUSCH transmission. In other words, if the total transmission power of the UE 102 would exceed \hat{P}_{CMAX}(i), then the UE 102 may scale \hat{P}_{PUSCH,c}(i) for the serving cell c in subframe i such that the condition of equation (1) is satisfied.

$${\sum }_{c}^{ } w ( i ) \cdot {\hat{P}}_{PUSCH , c} ( i ) \leq ( {\hat{P}}_{CMAX} ( i ) - {\hat{P}}_{Allocated} ( i ) ) \qquad ( 1 )$$

In equation (1), \hat{P}_{Allocated}(i) is the linear value of power allocated for the physical channel (e.g., PRACH, PUCCH or PUSCH) of a cell group with a higher priority with any overlapping in subframe i, \hat{P}_{PUSCH,c}(i) is the linear value of P_{PUSCH,c}(i) \hat{P}_{CMAX}(i) is the linear value of the UE 102 total configured maximum output power P_{CMAX} in subframe i and w(i) is a scaling factor of \hat{P}_{PUSCH,c}(i) for serving cell c, where 0≦w(i)≦1.

In one example, the higher priority signal transmitted on a cell group, \hat{P}_{Allocated}(i), may be \hat{P}_{PUCCH}(i) if the higher priority signal is transmitted on a PUCCH. In another example, \hat{P}_{Allocated}(i) may be \hat{P}_{PUSCH}(i) if the higher priority signal is transmitted on a PUSCH with or without UCI. In yet another example, \hat{P}_{Allocated}(i) may be (\hat{P}_{PUSCH}(i)+\hat{P}_{PUSCH}(i)) if the higher priority signals are transmitted simultaneously on PUCCH and PUSCH.

The UE 102 may determine 406 if UCI is carried on a PUSCH transmission for a cell group. For PUSCH transmissions, a PUSCH with UCI may be prioritized over a PUSCH without UCI. Therefore, in a power limited case, the PUSCH without UCI may be dropped or power scaled before the PUSCH with UCI within each cell group.

Even with the priority rules described herein, the dropping and power scaling procedures for PUSCH may be further defined. Specifically, the dropping and power scaling procedures may be further defined for PUSCH with UCI. In the case of simultaneous transmission of PUSCH with HARQ-ACK on one cell group and PUCCH with CSI on another cell group, simply dropping a PUCCH with CSI on the other cell group may cause bad channel estimation for the cell group associated with the dropped PUCCH. Similarly, in the case of simultaneous transmission of PUSCH with CSI on one cell group and PUCCH with HARQ-ACK and/or CSI on another cell group, simply dropping PUSCH with CSI on the cell group may also cause bad channel estimation for the associated cell group.

The UE 102 may determine 408 if the total transmission power of all cell groups with UCI-only transmissions exceeds the maximum allowed transmission power of the UE 102. In one configuration, the UE 102 may assume a UCI-only transmission on a PUSCH. In other words, the UE 102 may evaluate whether the total transmission power of all cell groups still exceeds the maximum allowed transmission power of the UE 102 by dropping the PUSCH without UCI and the data portion of a PUSCH with UCI. If the total transmission power is less than the maximum allowed transmission power of the UE 102, the UE 102 should transmit UCI on PUSCH assuming a UCI-only PUSCH report. Further power scaling may be applied for the PUSCH data transmission.

If the total transmission power with UCI-only on PUSCH still exceeds the maximum allowed transmission power of the UE 102, the UE 102 should use the priority rules described above to determine channel dropping based on uplink channel type and UCI type. For example, if the UCI on the PUSCH transmission on a cell group has lower priority, the PUSCH with UCI of the cell group should be dropped. If the UCI on the PUSCH transmission on a cell group has higher priority than the uplink channel 121 of the other cell group, the PUSCH with UCI on the given cell group should be transmitted.

In another configuration, the UE 102 may assume a UCI transmission on a PUCCH. A PUSCH with data transmission normally requires more power than a PUCCH transmission. Therefore, as an alternative to evaluating UCI on PUSCH-only transmissions on a cell group, the UE 102 may perform a UCI on PUCCH transmission instead of PUSCH on the cell group.

If the total transmit power of the UE 102 would exceed \hat{P}_{CMAX}(i), the UE 102 may scale \hat{P}_{PUSCH,c}(i) for the serving cell c in subframe i such that the condition

$${\sum }_{c}^{ } w ( i ) \cdot {\hat{P}}_{PUSCH , c} ( i ) \leq ( {\hat{P}}_{CMAX} ( i ) - {\hat{P}}_{PUCCH} ( i ) )$$

is satisfied, where \hat{P}_{PUCCH}(i) is the linear value of P_{PUCCH}(i), \hat{P}_{PUSCH,c}(i) is the linear value of P_{PUSCH,c}(i), \hat{P}_{CMAX}(i) is the linear value of the UE 102 total configured maximum output power P_{CMAX} in subframe i and w(i) is a scaling factor of \hat{P}_{PUSCH,c}(i) for serving cell c, where 0≦w(i)≦1. In the case when there is no PUCCH transmission in subframe i, \hat{P}_{PUCCH}(i)=0.

If the UE 102 has a PUSCH transmission with UCI on serving cell j and PUSCH without UCI in any of the remaining serving cells, and the total transmit power of the UE 102 would exceed \hat{P}_{CMAX}(i), the UE 102 may scale \hat{P}_{PUSCH,c}(i) for the serving cells without UCI in subframe i such that the condition

$${\sum }_{c \neq j}^{ } w ( i ) \cdot {\hat{P}}_{PUSCH , c} ( i ) \leq ( {\hat{P}}_{CMAX} ( i ) - {\hat{P}}_{PUSCH , j} ( i ) )$$

is satisfied, where \hat{P}_{PUSCH,j}(i) is the PUSCH transmit power for the cell with UCI and w(i) is a scaling factor of \hat{P}_{PUSCH,c}(i) for serving cell c without UCI. In this case, no power scaling is applied to \hat{P}_{PUSCH,j}(i) unless

$${\sum }_{c \neq j}^{ } w ( i ) \cdot {\hat{P}}_{PUSCH , c} ( i ) = 0$$

and the total transmit power of the UE 102 still would exceed \hat{P}_{CMAX}(i). It should be noted that the w(i) values are the same across serving cells when w(i)>0, but for certain serving cells w(i) may be zero.

If the UE has simultaneous PUCCH and PUSCH transmission with UCI on serving cell j and PUSCH transmission without UCI in any of the remaining serving cells, and the total transmit power of the UE 102 would exceed \hat{P}_{CMAX}(i), the UE 102 may obtain P̅_{PUSCH,c}(i) according to equations (1) and (2).

\hat{P}_{PUSCH,j}(i)=min(\hat{P}_{PUSCH,j}(i),(\hat{P}_{CMAX}(i)−\hat{P}_{PUCCH}(i))) (1)

$${\sum }_{c \neq j}^{ } w ( i ) \cdot {\hat{P}}_{PUSCH , c} ( i ) \leq ( {\hat{P}}_{CMAX} ( i ) - {\hat{P}}_{PUCCH} ( i ) - {\hat{P}}_{PUSCH , j} ( i ) ) \qquad ( 2 )$$

The UE 102 may transmit 410 the UCI and channels on the cell groups. For UCI multiplexing on a PUSCH, different multiplexing rules and resource elements may be used based on the UCI type. RI and HARQ-ACK may be multiplexed from the bottom of the PUSCH resource besides the DMRS symbols. PMI and CQI may be multiplexed from the beginning of the PUSCH resource. Also, different beta-offset values may be configured for different UCI types. Therefore, for UCI multiplexing with PUSCH, the UE 102 should differentiate UCI transmission and PUSCH data transmission, and give priority to the UCI transmission.

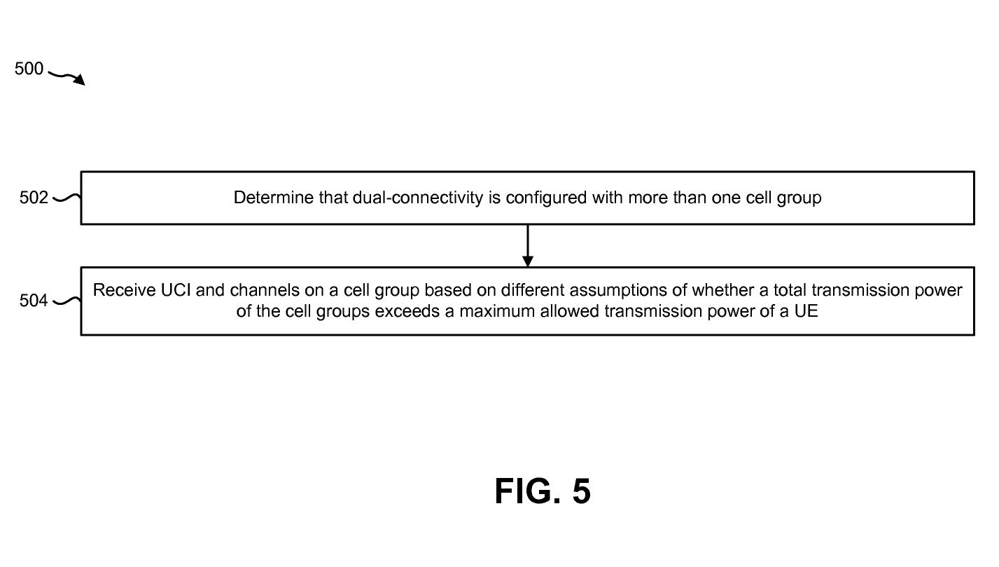

FIG. 5 is a flow diagram illustrating one implementation of a method 500 for dual-connectivity operation by an eNB 160. In dual-connectivity, an eNB 160 may provide multiple cells 351 for connection to one or more UEs 102. The eNB 160 may provide a radio connection 353 for the one or more cells 351. The one or more cells 351 may form a cell group. If the eNB 160 supports dual-connectivity, the eNB 160 may determine 502 that dual-connectivity is configured with more than one cell group. For example, the eNB 160 may provide one cell group and another eNB 160 may provide a second cell group. The cell group may be an MCG 155 or an SCG 157.

The eNB 160 may receive 504 UCI and channels on a cell group based on different assumptions of whether a total scheduled transmission power of the cell groups exceeds a maximum allowed transmission power of a UE 102 (Pcmax). If the total scheduled transmission power of the cell groups does not exceed the maximum allowed transmission power of the UE 102, then the UE 102 is in a power unlimited case. In this case, simultaneous uplink transmission from the MCG 155 and the SCG 157 should be performed independently by the UE 102. The eNB 160 may expect to receive the uplink channels 121 on the cell group with the scheduled power.

If the total scheduled transmission power of the cell groups exceeds the maximum allowed transmission power of the UE 102, then the UE 102 is in a power limited case. In this case, if the total uplink transmission powers on the MCG 155 and the SCG 157 exceeds the maximum allowed transmission power of the UE 102, the eNB 160 may receive 504 UCI and/or channels based on uplink channel prioritization and power scaling on one or both uplink channels 121 so that the total transmission power is within the power limit. An uplink channel 121 with the lower priority may be dropped or power scaled down before an uplink channel 121 with higher priority. The eNB 160 may receive 504 the UCI and/or channels for a cell group based on the priority rules described above in connection with FIG. 4. Thus, the eNB may expect that some of the scheduled uplink transmissions or channels are dropped or transmitted with reduced power.

The eNB 160 may also receive 504 UCI and channels on a cell group based on whether UCI is scheduled to be carried on a PUSCH transmission for the cell group. For PUSCH transmissions, a PUSCH with UCI may be prioritized over a PUSCH without UCI. Therefore, in a power limited case, the eNB 160 may expect that the PUSCH without UCI may be dropped or power scaled before the PUSCH with UCI within each cell group.

The eNB 160 may further receive 504 UCI and channels on a cell group based on different assumptions of whether a total transmission power of all cell groups with UCI-only transmissions exceeds the maximum allowed transmission power of the UE 102. In one configuration, if the total transmission power of all cell groups with a UCI-only transmission on a PUSCH is less than the maximum allowed transmission power of the UE 102, the eNB 160 may receive 504 UCI on the PUSCH in a UCI-only PUSCH report. The eNB 160 may expect further power scaling is applied for the PUSCH data transmission.

If the total transmission power with UCI-only on PUSCH still exceeds the maximum allowed transmission power of the UE 102, the eNB 160 may receive 504 UCI and channels based on the priority rules described above. The UCI and channel dropping may be based on uplink channel 121 type and UCI type. For example, if the UCI on the PUSCH transmission has lower priority, the PUSCH with UCI may be dropped. If the UCI on the PUSCH transmission has higher priority than the uplink channel 121 of the other cell group, the PUSCH with UCI on the given cell group may be received.

In another configuration, the eNB 160 may receive 504 a UCI transmission on a PUCCH. A PUSCH with data transmission normally requires more power than a PUCCH transmission. Therefore, as an alternative to receiving UCI on PUSCH-only transmissions, the eNB 160 may expect to receive UCI on a PUCCH transmission instead of a PUSCH transmission.

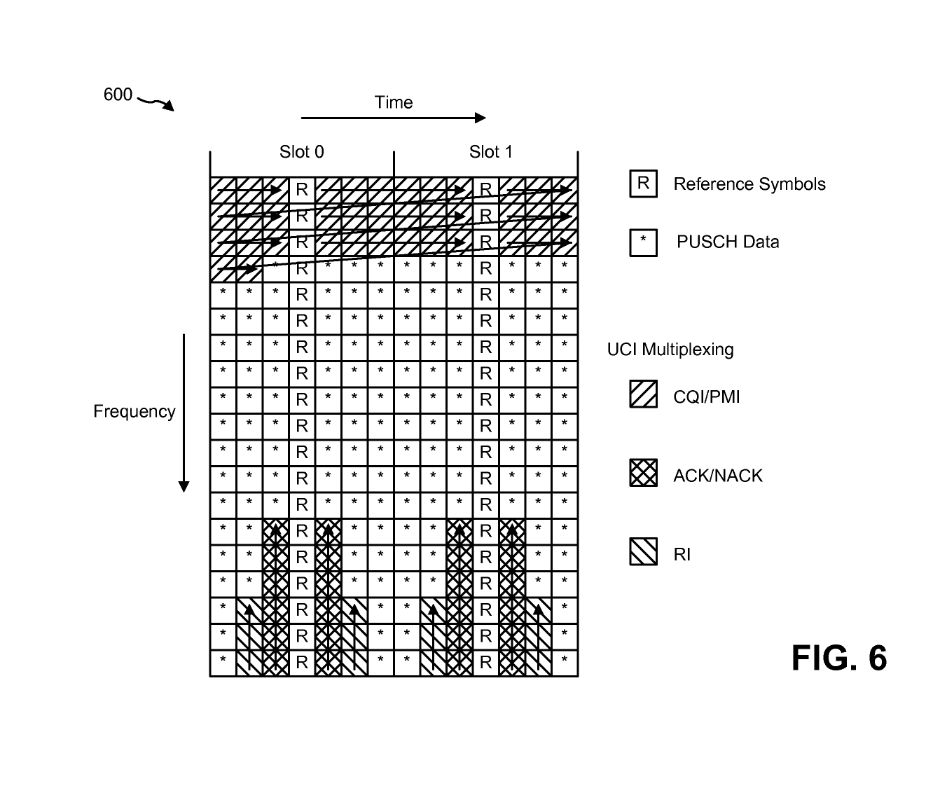

FIG. 6 illustrates a PUSCH transmission structure 600 with different UCI. The blocks illustrated in FIG. 6 correspond to resource elements of the PUSCH for slot 0 and slot 1. The resource elements are shown with their transmission frequency and time within each slot. The PUSCH transmission structure 600 includes reference symbols and PUSCH data.

The PUSCH transmission structure may also include UCI multiplexing. The UCI multiplexing may include channel quality indicator (CQI)/precoding matrix indication (PMI), acknowledgment/negative-acknowledgment (ACK/NACK) and/or rank indication (RI).

The arrows on the resource elements in FIG. 6 indicate how encoded symbols are multiplexed. For CQI/PMI, the encoded symbols are multiplexed in all symbols in time domain and from the top of the PUSCH region (e.g., top-down). The HARQ-ACK is multiplexed in the symbols besides the demodulation reference symbols in a bottom-up manner. Similarly, RI is multiplexed on symbols that are one symbol apart from the demodulation reference symbol.

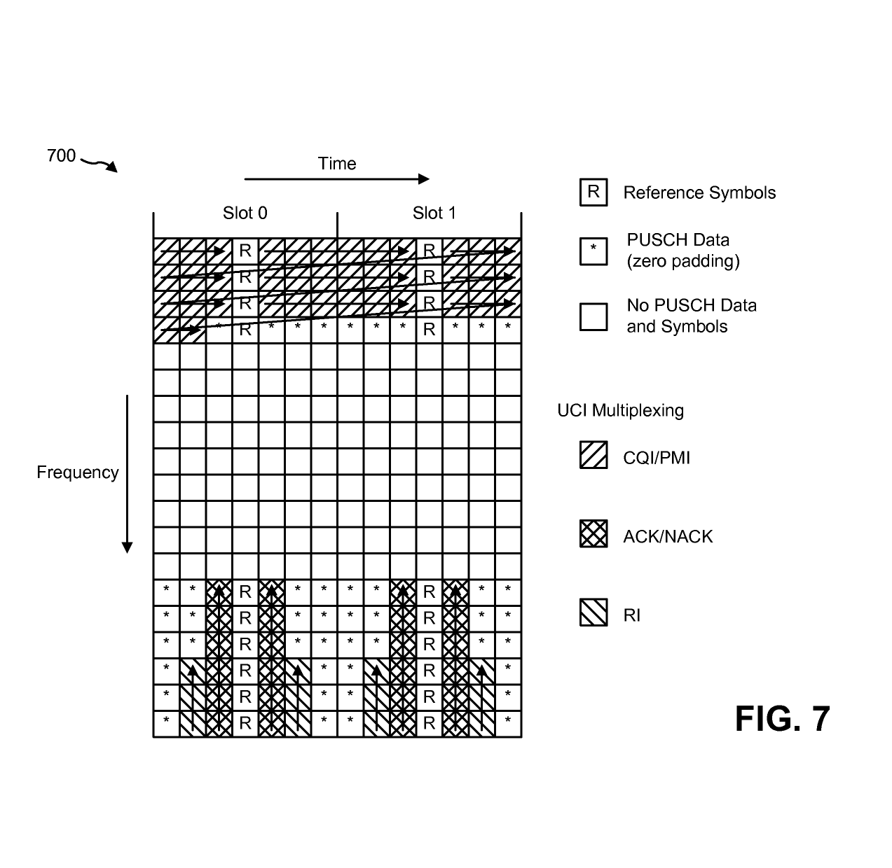

FIG. 7 illustrates a modified PUSCH transmission structure 700 with different UCI. The blocks illustrated in FIG. 6 correspond to resource elements of the PUSCH for slot 0 and slot 1. The resource elements are shown with their transmission frequency and time within each slot. The modified PUSCH transmission structure 700 includes reference symbols and PUSCH data. The PUSCH transmission structure may also include UCI multiplexing. The UCI multiplexing may include CQI/PMI, ACK/NACK and/or RI.

As illustrated in FIG. 7, the transmission powers of resource elements in the subcarriers with UCI information will not be reduced. However, the resource elements in other subcarriers can be used as place holders. For example, no signal or data is transmitted in the subcarriers that do not include UCI information.

To maintain the same PUSCH transmission power across all symbols, however, the symbols in the resource elements that are included in the same frequency subcarriers with any UCI transmissions should maintain the same power as UCI resource elements. In this case, the symbols can be the original PUSCH data, or the symbols can be generated with zero padding.

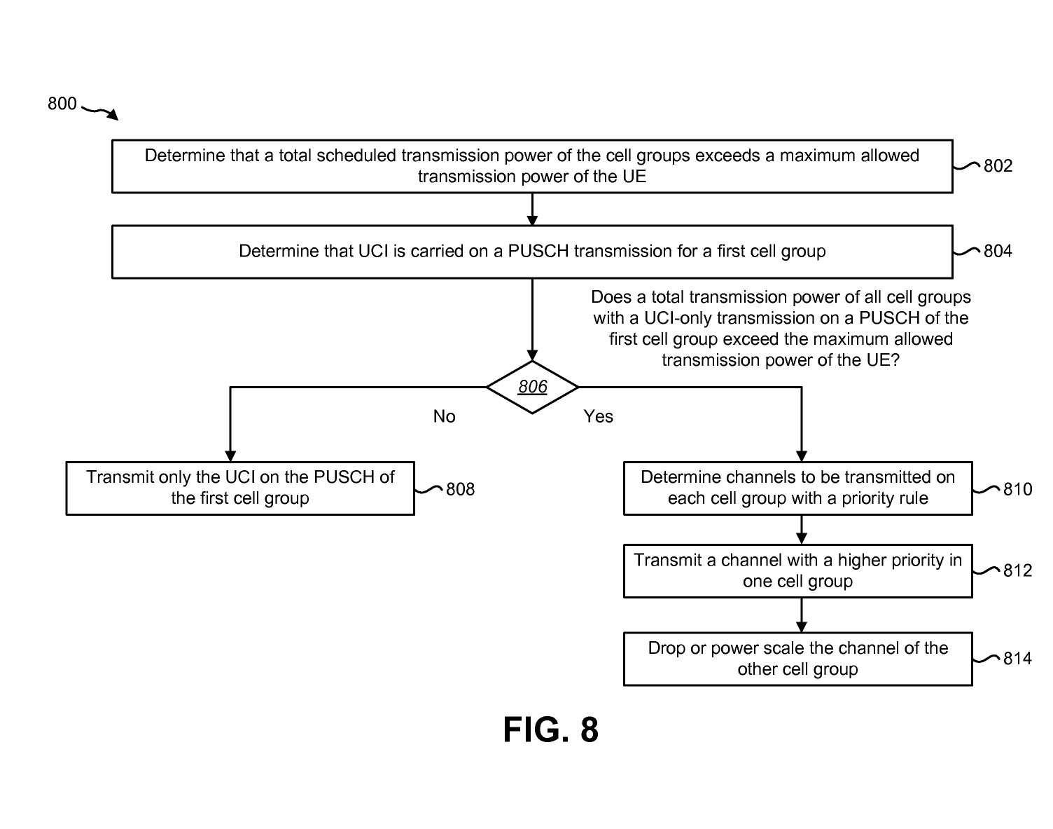

FIG. 8 is a flow diagram illustrating a detailed implementation of a method 800 for dual-connectivity operation by a UE 102. If the UE 102 supports dual-connectivity, the UE 102 may determine that dual-connectivity is configured with more than one cell group. For example, the UE 102 may be connected to an MCG 155 and an SCG 157.

The UE 102 may determine 802 that a total scheduled transmission power of the cell groups exceeds a maximum allowed transmission power of the UE 102 (Pcmax). In this case, the total scheduled uplink transmission powers on the MCG 155 and the SCG 157 exceeds the maximum allowed transmission power of the UE 102. Therefore, the UE 102 is in a power limited case.

The UE 102 may determine 804 that UCI is carried on a PUSCH transmission for a first cell group. In one configuration, the first cell group may be a cell group carrying a lower priority channel or UCI. In another configuration, the first cell group may be a cell group carrying a higher priority channel or UCI. For PUSCH transmissions, a PUSCH with UCI may be prioritized over a PUSCH without UCI. Therefore, in a power limited case, the PUSCH without UCI may be dropped or power scaled before the PUSCH with UCI within each cell group.

The channel dropping and power allocation should be evaluated in one or more steps in a power limited case if UCI is carried on PUSCH of cell j on a cell group, as illustrated in equation (3).

$${\hat{P}}_{Allocated} ( i ) + {\sum }_{c \neq j}^{ } {\hat{P}}_{PUSCH , c} ( i ) + {\hat{P}}_{PUSCH , j} ( i ) > {\hat{P}}_{CMAX} ( i ) \qquad ( 3 )$$

In equation (3), \hat{P}_{Allocated}(i) is the linear value of power allocated for the physical channel (e.g., PRACH, PUCCH or PUSCH) of a cell group with a higher priority with any overlapping in subframe i. \hat{P}_{PUSCH,c}(i) is the estimated PUSCH power without UCI. \hat{P}_{PUSCH,j}(i) is the estimated PUSCH power of cell j with UCI and data.

The UE 102 may determine 806 whether a total transmission power of all cell groups with a UCI-only transmission on a PUSCH of the first cell group exceeds the maximum allowed transmission power of the UE 102. The UE 102 may evaluate if the total transmission power still exceeds the maximum allowed transmission power of the UE 102 by dropping the PUSCH without UCI. In this case, if \hat{P}_{Allocated}(i)+\hat{P}_{PUSCH,j}(i)≦\hat{P}_{CMAX}(i), the UE 102 may drop or power scale the PUSCH without UCI on cell j so that

$${\sum }_{c \neq j}^{ } w ( i ) \cdot {\hat{P}}_{PUSCH , c} ( i ) \leq ( {\hat{P}}_{CMAX} ( i ) - {\hat{P}}_{Allocated} ( i ) - {\hat{P}}_{PUSCH , j} ( i ) ) .$$

If the total power does not exceed the maximum allowed transmission power of the UE 102, the UE 102 may drop the PUSCH without UCI on cell c and further evaluate as described below.

The UE 102 may evaluate if the UCI can be carried on the PUSCH resource of a cell group by assuming a UCI-only PUSCH reporting for the given cell group. In other words, the UE 102 may evaluate if the UCI can be carried on the PUSCH resource by dropping the PUSCH data part. Reducing the number of resource elements for a PUSCH effectively reduces the transmission power of a PUSCH.

If the UE 102 determines 806 that the total transmission power does not exceed (e.g., is less than) the maximum allowed transmission power of the UE 102, the UE 102 may transmit 808 only the UCI on the PUSCH of the first cell group. The UE 102 may transmit the UCI on PUSCH assuming a UCI-only PUSCH report. Additionally, if there is still remaining power, the UE 102 may apply power scaling on the PUSCH data transmission. Therefore, if \hat{P}_{Allocated}(i)+\hat{P}_{PUSCH,j}_{_{—}}_{UCI}(i)≦\hat{P}_{CMAX}(i), the UE 102 may transmit UCI on PUSCH as a UCI-only transmission with a given power, where \hat{P}_{PUSCH,j}_{_{—}}_{UCI}(i) is the linear value of power allocated for a UCI-only transmission on PUSCH. The UE 102 may drop the data from the PUSCH transmission.

Currently, all resource elements of the PUSCH have the same transmission power, as shown in FIG. 6. The transmission powers in resource elements in the subcarriers with UCI information will not be reduced. In one configuration, the resource elements in other subcarriers can be used as place holders. In other words, no signal or data is transmitted, as shown in FIG. 7. However, to maintain the same PUSCH transmission power across all symbols, the symbols in the resource elements that are included in the same frequency subcarriers with any UCI transmissions should maintain the same power as UCI resource elements. The symbols can be the original PUSCH data, or they can be generated with zero padding. Thus, the described systems and methods allow non-uniform power allocation on a PUSCH based on the type of information carried on the subcarriers or resource elements.

If the UE 102 determines 806 that the total transmission power still exceeds the maximum allowed transmission power of the UE 102 even with a UCI-only transmission on the PUSCH of the first cell group, then the UE 102 may determine 810 channels to be transmitted on each cell group with a priority rule based on UCI type and channel type. The UE 102 may determine channel dropping based on uplink channel type and UCI type according to the priority rules described above in connection with FIG. 4.

If the UCI on the PUSCH transmission has a lower priority, the PUSCH transmission with UCI should be dropped. If the UCI on the PUSCH transmission on a given cell group has higher priority than the uplink channel 121 of the other cell group, the PUSCH transmission with UCI on the given cell group should be transmitted, and the uplink channel 121 on the other cell group should be dropped or power scaling should be applied, if applicable. In other words, if \hat{P}_{Allocated}(i)+\hat{P}_{PUSCH,j}_{_{—}}_{UCI}(i)≧\hat{P}_{CMAX}(i), then the UE 102 may determine the channel to be transmitted based on UCI type and channel type priority.

Based on the results of the priority rule, the UE 102 may transmit 812 a channel with a higher priority in one cell group. The UE 102 may drop 814 or power scale the channel of the other cell group with lower priority.

The described systems and methods separate the UCI on a PUSCH transmission from the data part of the PUSCH transmission. This may reduce unnecessary dropping of UCI information on a PUCCH or PUSCH in a power limited case.

In one configuration, the dropping is determined by UCI type for the case of simultaneous (MCG PUCCH+SCG PUSCH with UCI), and (MCG PUSCH with UCI and SCG PUCCH or PUSCH with UCI), (MCG PUSCH with UCI+SCG PUCCH) and (MCG PUSCH with UCI+SCG PUSCH with UCI).

In the case of PUSCH with UCI on both MCG 155 and SCG 157, a UE 102 should first evaluate a UCI-only transmission on PUSCH for the SCG 157. If the power limit is solved (e.g., the total transmission power of the cell groups does not exceed the maximum allowed transmission power of the UE 102), the UE 102 may drop the data part for the PUSCH on the SCG 157. If the total transmission power is still more than the maximum allowed transmission power of the UE 102, the UE 102 should evaluate a UCI-only transmission on PUSCH for both the SCG 157 and the MCG 155. If the power limit is solved, the UE 102 may apply the UCI-only transmission on both the MCG 155 and the SCG 157. If the total transmission power is still more than the maximum allowed transmission power of the UE 102, the UCI-type based priority rule for dropping should be further applied.

The priority rules may also be applied based on UCI type and channel formats if simultaneous PUCCH and PUSCH are configured in one or more cell groups. The UCI type should be evaluated first. If the UCI type is the same for the cell groups, then the channel type should be further evaluated as follows: MCG PUCCH (if present)>SCG PUCCH (if present)>MCG PUSCH with UCI (if present)>SCG PUSCH with UCI (if present)>MCG PUSCH without UCI>SCG PUSCH without UCI.

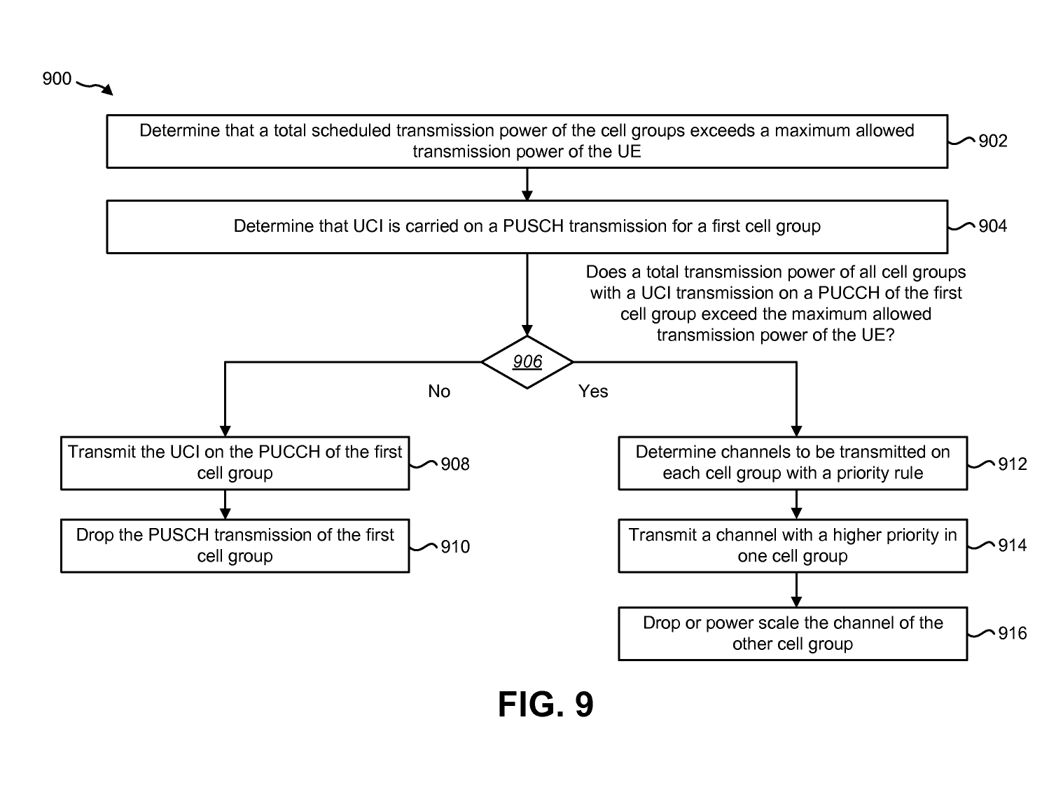

FIG. 9 is a flow diagram illustrating another detailed implementation of a method 900 for dual-connectivity operation by a UE 102. If the UE 102 supports dual-connectivity, the UE 102 may determine that dual-connectivity is configured with more than one cell group. For example, the UE 102 may be connected to an MCG 155 and an SCG 157.

The UE 102 may determine 902 that a total scheduled transmission power of the cell groups exceeds a maximum allowed transmission power of the UE 102 (Pcmax). In this case, the total scheduled uplink transmission powers on the MCG 155 and the SCG 157 exceeds the maximum allowed transmission power of the UE 102. Therefore, the UE 102 is in a power limited case.

The UE 102 may determine 904 that UCI is carried on a PUSCH transmission for a first cell group. In one configuration, the first cell group may be a cell group carrying a lower priority channel or UCI. In another configuration, the first cell group may be a cell group carrying a higher priority channel or UCI. In a power limited case, if UCI is carried on PUSCH on one cell group (e.g., the first cell group), channel dropping and power allocation may be evaluated in several steps.

A PUSCH with data transmission normally requires more power than a PUCCH transmission. As an alternative to evaluating UCI on PUSCH-only transmissions, the UE 102 may perform UCI on a PUCCH transmission instead of a PUSCH transmission.

The UE 102 may determine 906 whether a total transmission power of all cell groups with a UCI transmission on a PUCCH of the first cell group exceeds the maximum allowed transmission power of the UE 102. In other words, the UE 102 may evaluate if the UCI can be carried on PUCCH instead of PUSCH and whether to drop the PUSCH transmission. In one implementation, the existing Rel-8/9/10/11/12 UCI on PUCCH resources and PUCCH formats may be reused for HARQ-ACK and CSI. Furthermore, SR reports may be on PUCCH Format 1/1a/1b, PUCCH Format 2/2a/2b and PUCCH format 3. Some UCI (e.g., the aperiodic CSI) may be dropped in a PUCCH report.

If the UE 102 determines 906 that the total transmission power does not exceed (e.g., is less than) the maximum allowed transmission power of the UE 102, the UE 102 may transmit 908 the UCI on PUCCH of the first cell group. The UE 102 may drop 910 the PUSCH transmission of the first cell group.

If the UE 102 determines 906 that the total transmission power still exceeds the maximum allowed transmission power of the UE 102 even with a UCI transmission on the PUCCH of the first cell group, the UE 102 may determine 912 channels to be transmitted on each cell group with a priority rule based on UCI type and channel type. The UE 102 may determine 912 channel dropping based on uplink channel 121 type and UCI type according to the priority rules described above in connection with FIG. 4. If the UCI on the PUSCH transmission has lower priority, the PUSCH with UCI should be dropped. If the UCI on the PUSCH transmission has higher priority than the uplink channel 121 of the other cell group, the PUSCH with UCI on the given cell group should be transmitted, and the uplink channel 121 on the other cell group should be dropped or power scaling applied, if applicable.

Based on the results of the priority rule, the UE 102 may transmit 914 a channel with a higher priority in one cell group. The UE 102 may drop 916 or power scale the channel of the other cell group with lower priority.

In one configuration, if \hat{P}_{Allocated}(i)+\hat{P}_{PUCCH}(i)≦\hat{P}_{CMAX}(i), the UE 102 may transmit UCI on the PUCCH, and may drop the PUSCH. In this configuration, \hat{P}_{PUCCH}(i) is the linear value of power allocated for UCI transmission on the PUCCH instead of the PUSCH.

In the case of PUSCH with UCI on both the MCG 155 and the SCG 157, the UE 102 should first evaluate UCI on the PUCCH transmission for the SCG 157. If the power limitation is solved, the UE 102 may drop the PUSCH on the SCG 157 and may transmit the PUCCH. If the total transmission power is still more than the maximum allowed transmission power of the UE 102, the UE 102 should evaluate UCI on the PUCCH of both the SCG 157 and the MCG 155. If the total transmission power is still more than the maximum allowed transmission power of the UE 102, UCI-type based dropping should be further applied using the priority rules, as described above.

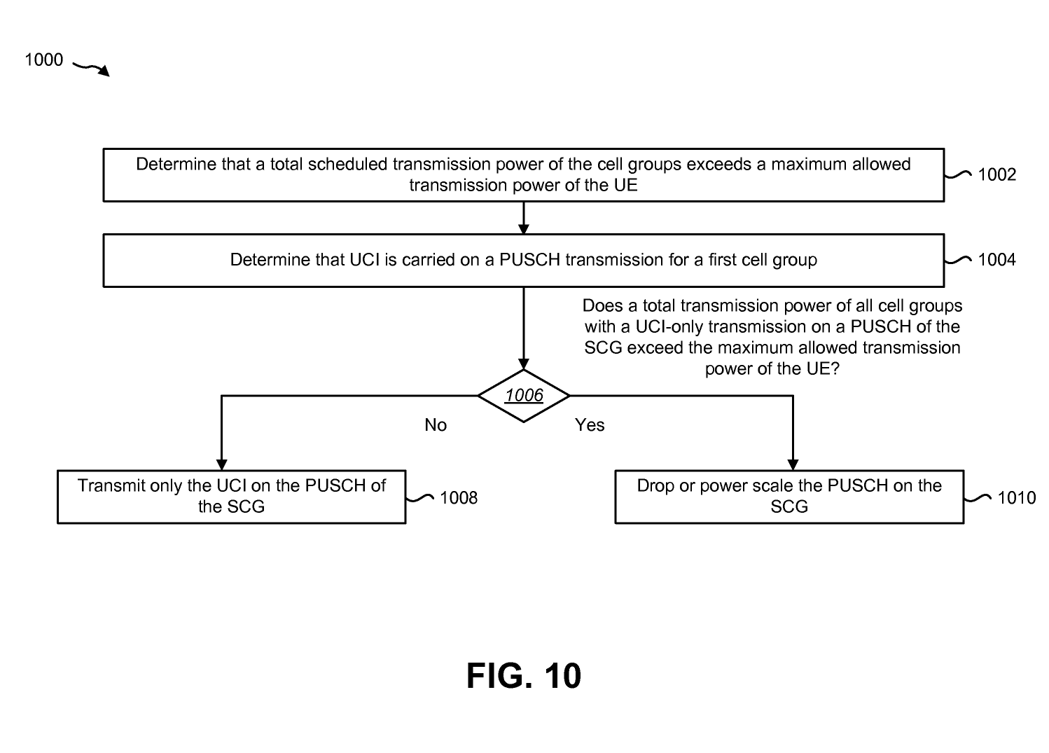

FIG. 10 is a flow diagram illustrating yet another detailed implementation of a method 1000 for dual-connectivity operation by a UE 102. If the UE 102 supports dual-connectivity, the UE 102 may determine that dual-connectivity is configured with more than one cell group. For example, the UE 102 may be connected to an MCG 155 and an SCG 157.

The UE 102 may determine 1002 that a total scheduled transmission power of the cell groups exceeds a maximum allowed transmission power of the UE 102 (Pcmax). In this case, the total scheduled uplink transmission powers on the MCG 155 and the SCG 157 exceeds the maximum allowed transmission power of the UE 102. Therefore, the UE 102 is in a power limited case.

The UE 102 may determine 1004 that UCI is carried on a PUSCH transmission for an SCG 157. In one configuration, the MCG 155 may have higher priority than the SCG 157. In this configuration, the PUSCH transmission on the MCG 155 may have a higher priority than UCI on the SCG 157. Thus, the priority is defined with MCG PUCCH>MCG PUSCH>SCG PUCCH>SCG PUSCH with UCI>SCG PUSCH without UCI.

The UE 102 may determine 1006 if a total transmission power of all cell groups with a UCI-only transmission on a PUSCH of the SCG 157 exceeds the maximum allowed transmission power of the UE 102. In the case of the PUSCH with UCI on SCG 157, the UE 102 should evaluate if the UCI can be carried on the PUSCH resource assuming a UCI-only PUSCH reporting on the SCG 157.

If the UE 102 determines 1006 that the total transmission power does not exceed (e.g., is less than) the maximum allowed transmission power of the UE 102, the UE 102 may transmit 1008 the UCI only on the PUSCH of the SCG 157. In this case, the UE 102 may assume a UCI-only PUSCH report. Additionally, if there is still remaining power, power scaling may be applied on the PUSCH data transmission. No power scaling is applied to \hat{P}_{PUSCH,j}(i) unless

$${\sum }_{c \neq j} w ( i ) \cdot {\hat{P}}_{PUSCH , c} ( i ) = 0$$

and the total transmission power of the UE 102 still would exceed \hat{P}_{CMAX}(i)−\hat{P}_{MCG}(i).

If the UE 102 determines 1006 that the total transmission power still exceeds the maximum allowed transmission power of the UE 102 even with a UCI-only transmission on the PUSCH of the SCG 157, then the UE 102 may drop 1010 or power scale the PUSCH with the UCI on the SCG 157.

The steps of method 1000 may be summarized according to the pseudo code of Listing (1).

Listing (1)

If \hat{P}_{MCG}(i) + \hat{P}_{PUSCH, j}(i) ≦ \hat{P}_{CMAX}(i)

If \hat{P}_{MCG}(i) + \hat{P}_{PUSCH, j}_{_{—}}_{UCI}(i) ≦ \hat{P}_{CMAX}(i)

Transmit UCI on the PUSCH as UCI only with a given power,
and drop data

Else

Drop or power scale the PUSCH with the UCI on the SCG

End if

End if

In Listing (1), \hat{P}_{MCG}(i) is the linear value of power allocated for the MCG 155 transmission with any overlapping in subframe i. \hat{P}_{PUSCH,j}_{_{—}}_{UCI}(i) is the linear value of power allocated for a UCI-only transmission on the PUSCH of cell j.

In another implementation, the UE 102 may also evaluate PUSCH transmissions without UCI of serving cells of the SCG 157. In this implementation, if the total transmission power of PUSCH transmissions without UCI of the serving cells of the SCG 157 exceeds the maximum allowed transmission power of the UE 102 minus the allocated power for the MCG 155 minus at least one of a PUCCH transmission with UCI or a PUSCH transmission with UCI of the serving cell of the SCG 157, then the UE 102 may drop or power scale the PUSCH without UCI on the SCG 157.

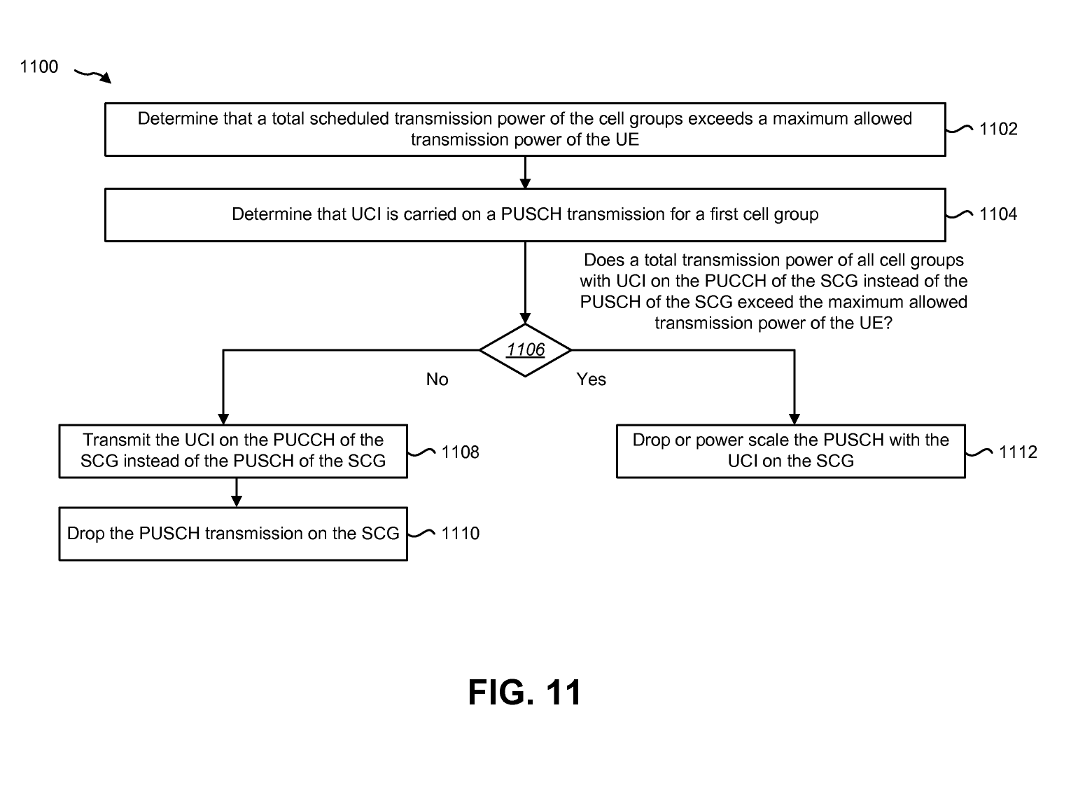

FIG. 11 is a flow diagram illustrating another detailed implementation of a method 1100 for dual-connectivity operation by a UE 102. If the UE 102 supports dual-connectivity, the UE 102 may determine that dual-connectivity is configured with more than one cell group. For example, the UE 102 may be connected to an MCG 155 and an SCG 157.

The UE 102 may determine 1102 that a total scheduled transmission power of the cell groups exceeds a maximum allowed transmission power of the UE 102 (Pcmax). In this case, the total scheduled uplink transmission powers on the MCG 155 and the SCG 157 exceed the maximum allowed transmission power of the UE 102. Therefore, the UE 102 is in a power limited case.

The UE 102 may determine 1104 that UCI is carried on a PUSCH transmission for an SCG 157. In one configuration, between the cell groups, MCG 155 should have higher priority than the SCG 157. Thus, the PUSCH transmission on an MCG 155 may have a higher priority than UCI on an SCG 157. In this case, the priority is defined with MCG PUCCH>MCG PUSCH>SCG PUCCH>SCG PUSCH with UCI>SCG PUSCH without UCI. Thus, no power scaling is applied for an MCG PUCCH and/or an MCG PUSCH transmission.

The UE 102 may determine 1106 if a total transmission power of all cell groups with a UCI on the PUCCH of the SCG 157 instead of the PUSCH of the SCG 157 exceeds the maximum allowed transmission power of the UE 102. As described above, a PUSCH transmission with data normally requires more power than a PUCCH transmission. As an alternative to evaluating UCI on PUSCH-only transmissions, the UE 102 may perform UCI on a PUCCH transmission instead of a PUSCH transmission. In the case of PUSCH with UCI on the SCG 157, the UE 102 should evaluate if the UCI can be carried on the PUCCH of the SCG 157 instead of PUSCH of the SCG 157.

If the UE 102 determines 1106 that the total transmission power does not exceed (e.g., is less than) the maximum allowed transmission power of the UE 102, the UE should transmit 1108 the UCI on PUCCH of the SCG 157 instead of the PUSCH of the SCG. The UE 102 may drop 1110 the PUSCH transmission on the SCG 157.

If the UE 102 determines 1106 that the total transmission power still exceeds the maximum allowed transmission power of the UE 102 even with the UCI on the PUCCH of the SCG 157 instead of the PUSCH of the SCG 157, then the UE 102 may drop 1112 or power scale the PUSCH with the UCI on the SCG 157.

The steps of method 1100 may be summarized according to the pseudo code of Listing (2).

Listing (2)

If \hat{P}_{MCG}(i) + \hat{P}_{PUSCH, j}(i) ≦ \hat{P}_{CMAX}(i)

If P_{MCG}(i) + \hat{P}_{PUCCH}(i) ≦ \hat{P}_{CMAX}(i)

Transmit UCI on the PUCCH of the SCG instead of the PUSCH
of the SCG, drop the PUSCH of the SCG

Else

Drop or power scale the PUSCH with the UCI on the SCG

End if

End if

In Listing (2), \hat{P}_{MCG}(i) is the linear value of power allocated for the MCG 155 transmission with any overlapping in subframe i. \hat{P}_{PUCCH}(i) is the linear value of power allocated for UCI transmission on the PUCCH instead of the PUSCH.

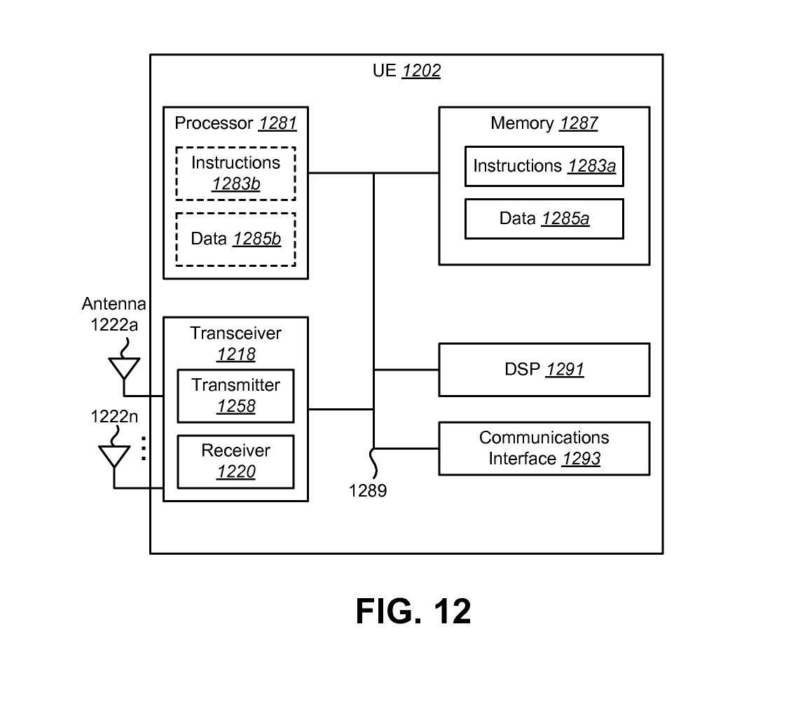

FIG. 12 illustrates various components that may be utilized in a UE 1202. The UE 1202 described in connection with FIG. 12 may be implemented in accordance with the UE 102 described in connection with FIG. 1. The UE 1202 includes a processor 1281 that controls operation of the UE 1202. The processor 1281 may also be referred to as a central processing unit (CPU). Memory 1287, which may include read-only memory (ROM), random access memory (RAM), a combination of the two or any type of device that may store information, provides instructions 1283a and data 1285a to the processor 1281. A portion of the memory 1287 may also include non-volatile random access memory (NVRAM). Instructions 1283b and data 1285b may also reside in the processor 1281. Instructions 1283b and/or data 1285b loaded into the processor 1281 may also include instructions 1283a and/or data 1285a from memory 1287 that were loaded for execution or processing by the processor 1281. The instructions 1283b may be executed by the processor 1281 to implement one or more of the methods 400, 800, 900, 1000 and 1100 described above.

The UE 1202 may also include a housing that contains one or more transmitters 1258 and one or more receivers 1220 to allow transmission and reception of data. The transmitter(s) 1258 and receiver(s) 1220 may be combined into one or more transceivers 1218. One or more antennas 1222a-n are attached to the housing and electrically coupled to the transceiver 1218.

The various components of the UE 1202 are coupled together by a bus system 1289, which may include a power bus, a control signal bus and a status signal bus, in addition to a data bus. However, for the sake of clarity, the various buses are illustrated in FIG. 12 as the bus system 1289. The UE 1202 may also include a digital signal processor (DSP) 1291 for use in processing signals. The UE 1202 may also include a communications interface 1293 that provides user access to the functions of the UE 1202. The UE 1202 illustrated in FIG. 12 is a functional block diagram rather than a listing of specific components.

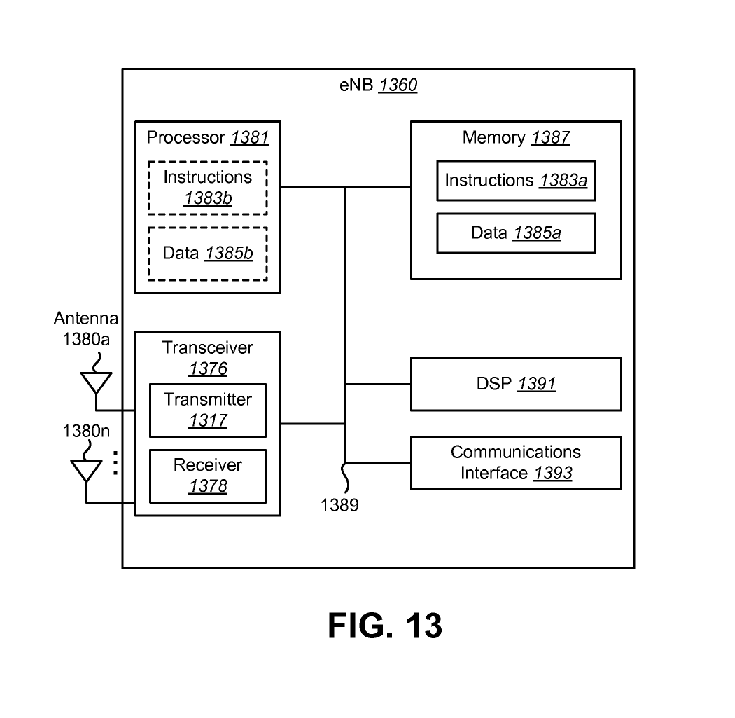

FIG. 13 illustrates various components that may be utilized in an eNB 1360. The eNB 1360 described in connection with FIG. 13 may be implemented in accordance with the eNB 160 described in connection with FIG. 1. The eNB 1360 includes a processor 1381 that controls operation of the eNB 1360. The processor 1381 may also be referred to as a central processing unit (CPU). Memory 1387, which may include read-only memory (ROM), random access memory (RAM), a combination of the two or any type of device that may store information, provides instructions 1383a and data 1385a to the processor 1381. A portion of the memory 1387 may also include non-volatile random access memory (NVRAM). Instructions 1383b and data 1385b may also reside in the processor 1381. Instructions 1383b and/or data 1385b loaded into the processor 1381 may also include instructions 1383a and/or data 1385a from memory 1387 that were loaded for execution or processing by the processor 1381. The instructions 1383b may be executed by the processor 1381 to implement the method 500 described above.

The eNB 1360 may also include a housing that contains one or more transmitters 1317 and one or more receivers 1378 to allow transmission and reception of data. The transmitter(s) 1317 and receiver(s) 1378 may be combined into one or more transceivers 1376. One or more antennas 1380a-n are attached to the housing and electrically coupled to the transceiver 1376.

The various components of the eNB 1360 are coupled together by a bus system 1389, which may include a power bus, a control signal bus and a status signal bus, in addition to a data bus. However, for the sake of clarity, the various buses are illustrated in FIG. 13 as the bus system 1389. The eNB 1360 may also include a digital signal processor (DSP) 1391 for use in processing signals. The eNB 1360 may also include a communications interface 1393 that provides user access to the functions of the eNB 1360. The eNB 1360 illustrated in FIG. 13 is a functional block diagram rather than a listing of specific components.

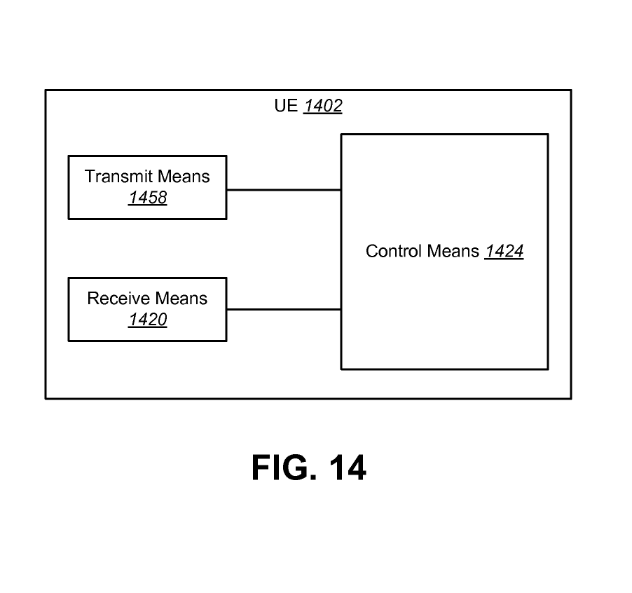

FIG. 14 is a block diagram illustrating one configuration of a UE 1402 in which systems and methods for sending feedback information may be implemented. The UE 1402 includes transmit means 1458, receive means 1420 and control means 1424. The transmit means 1458, receive means 1420 and control means 1424 may be configured to perform one or more of the functions described in connection with FIG. 4, FIG. 8, FIG. 9, FIG. 10 and FIG. 11 above. FIG. 12 above illustrates one example of a concrete apparatus structure of FIG. 14. Other various structures may be implemented to realize one or more of the functions of FIG. 4, FIG. 8, FIG. 9, FIG. 10 and FIG. 11. For example, a DSP may be realized by software.

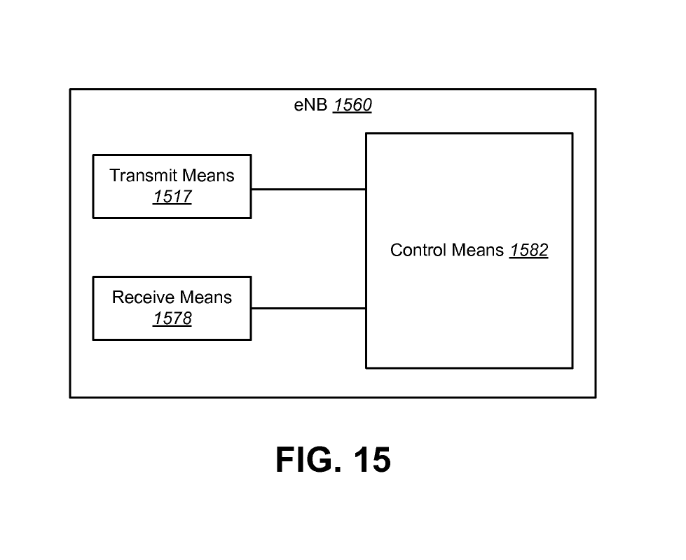

FIG. 15 is a block diagram illustrating one configuration of an eNB 1560 in which systems and methods for receiving feedback information may be implemented. The eNB 1560 includes transmit means 1517, receive means 1578 and control means 1582. The transmit means 1517, receive means 1578 and control means 1582 may be configured to perform one or more of the functions described in connection with FIG. 5 above. FIG. 13 above illustrates one example of a concrete apparatus structure of FIG. 15. Other various structures may be implemented to realize one or more of the functions of FIG. 5. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. A user equipment (UE), comprising:
a processor; and
memory in electronic communication with the processor, wherein instructions stored in the memory are executable to:
determine that dual-connectivity is configured with more than one cell group;
determine if a total scheduled transmission power of the cell groups exceeds a maximum allowed transmission power of the UE;
determine a priority of uplink control information (UCI) types and channel types among the cell groups;
determine if UCI is carried on a physical uplink shared channel (PUSCH) transmission for a cell group;
determine if total transmission power of all cell groups with UCI-only transmissions exceeds the maximum allowed transmission power of the UE; and
transmit UCI and channels on the cell groups.

2. The UE of claim 1, wherein if the total scheduled transmission power of the cell groups exceeds the maximum allowed transmission power of the UE, and if UCI is carried on a PUSCH transmission for a first cell group, and if a total transmission power of all cell groups with a UCI-only transmission on a PUSCH of the first cell group does not exceed the maximum allowed transmission power of the UE, then the instructions are further executable to:
transmit the UCI only on the PUSCH of the first cell group.

3. The UE of claim 1, wherein if the total scheduled transmission power of the cell groups exceeds the maximum allowed transmission power of the UE, and if UCI is carried on a PUSCH transmission for a first cell group, and if a total transmission power of all cell groups with a UCI-only transmission on a PUSCH of the first cell group exceeds the maximum allowed transmission power of the UE, then the instructions are further executable to:
transmit a channel with a higher priority in one cell group; and
drop or power scale the channel of the other cell group.

4. The UE of claim 1, wherein if the total scheduled transmission power of the cell groups exceeds the maximum allowed transmission power of the UE, and if UCI is carried on a PUSCH transmission for a first cell group, and if a total transmission power of all the cell groups with UCI on a physical uplink control channel (PUCCH) of the first cell group does not exceed the maximum allowed transmission power of the UE, then the instructions are further executable to:
transmit the UCI on PUCCH of the first cell group; and
drop the PUSCH transmission of the first cell group.

5. The UE of claim 1, wherein if the total scheduled transmission power of the cell groups exceeds the maximum allowed transmission power of the UE, and if UCI is carried on a PUSCH transmission for a first cell group, and if a total transmission power of all cell groups with UCI on a physical uplink control channel (PUCCH) of the first cell group exceeds the maximum allowed transmission power of the UE, then the instructions are further executable to:
transmit the channel with a higher priority in one cell group; and
drop or power scale the channel on the other cell group.

6. A user equipment (UE), comprising:
a processor; and
memory in electronic communication with the processor, wherein instructions stored in the memory are executable to:
determine that dual-connectivity is configured with more than one cell group; and
determine if a total scheduled transmission power of the cell groups exceeds a maximum allowed transmission power of the UE.

7. The UE of claim 6, wherein if the total scheduled transmission power of the cell groups exceeds the maximum allowed transmission power of the UE, and if UCI is carried on a PUSCH transmission for a secondary cell group (SCG), and if a total transmission power of all cell groups with a UCI-only transmission on a PUSCH of the SCG does not exceed the maximum allowed transmission power of the UE, then the instructions are further executable to:
transmit the UCI only on the PUSCH of the SCG.

8. The UE of claim 6, wherein if the total scheduled transmission power of the cell groups exceeds the maximum allowed transmission power of the UE, and if UCI is carried on a PUSCH transmission for a secondary cell group (SCG), and if a total transmission power of all cell groups with the UCI on a physical uplink control channel (PUCCH) of the SCG instead of a PUSCH of the SCG does not exceed the maximum allowed transmission power of the UE, then the instructions are further executable to:
transmit the UCI on the PUCCH of the SCG instead of the PUSCH of the SCG; and
drop the PUSCH transmission of the SCG.

9. The UE of claim 6, wherein if the total scheduled transmission power of the cell groups exceeds the maximum allowed transmission power of the UE, and if UCI is carried on a PUSCH transmission for a secondary cell group (SCG), and if a total transmission power of all cell groups with the UCI on a physical uplink control channel (PUCCH) of the SCG instead of a PUSCH of the SCG exceeds the maximum allowed transmission power of the UE, then the instructions are further executable to:
drop or power scale the PUSCH with the UCI on the SCG.

10. The UE of claim 6, wherein if the total scheduled transmission power of the cell groups exceeds the maximum allowed transmission power of the UE, and if the total transmission power of PUSCH transmissions without UCI of serving cells of a secondary cell group (SCG) exceeds the maximum allowed transmission power of the UE minus allocated power for a master cell group (MCG) minus at least one of a physical uplink control channel (PUCCH) transmission with UCI or a PUSCH transmission with UCI of the serving cell of the SCG, then the instructions are further executable to:
drop or power scale the PUSCH without UCI on the SCG.

11. An evolved NodeB (eNB), comprising:
a processor; and
memory in electronic communication with the processor, wherein instructions stored in the memory are executable to:
determine that dual-connectivity is configured with more than one cell group; and
receive uplink control information (UCI) and channels on a cell group, wherein the receiving is based on different assumptions of:
whether a total scheduled transmission power of the cell groups exceeds a maximum allowed transmission power of a user equipment (UE);
a priority of UCI types and channel types among the cell groups;
whether UCI is carried on a physical uplink shared channel (PUSCH) transmission for a cell group; and
whether a total transmission power of all cell groups with UCI-only transmissions exceeds the maximum allowed transmission power of the UE.

12. The eNB of claim 11, wherein if the total scheduled transmission power of the cell groups exceeds the maximum allowed transmission power of the UE, and if UCI is carried on a PUSCH transmission for a first cell group, then the instructions are further executable to:
receive UCI only on a PUSCH of the first cell group when a total transmission power of all cell groups with a UCI-only transmission on a PUSCH of the first cell group does not exceed the maximum allowed transmission power of the UE.

13. The eNB of claim 11, wherein if the total scheduled transmission power of the cell groups exceeds the maximum allowed transmission power of the UE, and if UCI is carried on a PUSCH transmission for a first cell group, then the instructions are further executable to:
receive a channel with a higher priority in one cell group when a total transmission power with a UCI-only transmission on a PUSCH of the first cell group exceeds the maximum allowed transmission power of the UE, wherein the channel of the other cell group is dropped or power scaled.

14. The eNB of claim 11, wherein if the total scheduled transmission power of the cell groups exceeds the maximum allowed transmission power of the UE, and if UCI is carried on a PUSCH transmission for a first cell group, then the instructions are further executable to:
receive the UCI on a physical uplink control channel (PUCCH) of the first cell group when a total transmission power of all cell groups with UCI on a physical uplink control channel (PUCCH) of the first cell group does not exceed the maximum allowed transmission power of the UE, wherein the PUSCH transmission of the first cell group is dropped.

15. The eNB of claim 11, wherein if the total scheduled transmission power of the cell groups exceeds the maximum allowed transmission power of the UE, and if UCI is carried on a PUSCH transmission for a first cell group, then the instructions are further executable to:
receive the channel with a higher priority in one cell group when a total transmission power of all cell groups with UCI on a physical uplink control channel (PUCCH) of the first cell group exceeds the maximum allowed transmission power of the UE, wherein the channel of the other cell group is dropped or power scaled.

16. The eNB of claim 11, wherein if the total scheduled transmission power of the cell groups exceeds the maximum allowed transmission power of the UE, and if UCI is carried on a PUSCH transmission for a secondary cell group (SCG), then the instructions are further executable to:
receive the UCI only on the PUSCH of the SCG when a total transmission power of all cell groups with a UCI-only transmission on a PUSCH of the SCG does not exceed the maximum allowed transmission power of the UE.

17. The eNB of claim 11, wherein if the total scheduled transmission power of the cell groups exceeds the maximum allowed transmission power of the UE, and if UCI is carried on a PUSCH transmission for a secondary cell group (SCG), then the instructions are further executable to:
receive the UCI on a physical uplink control channel (PUCCH) of the SCG instead of the PUSCH of the SCG when a total transmission power of all cell groups with the UCI on the PUCCH of the SCG instead of the PUSCH of the SCG does not exceed the maximum allowed transmission power of the UE, wherein the PUSCH transmission of the SCG is dropped.

18. A method for dual-connectivity operation by a user equipment (UE), comprising:
determining that dual-connectivity is configured with more than one cell group;
determining if a total scheduled transmission power of the cell groups exceeds a maximum allowed transmission power of the UE;
determining a priority of uplink control information (UCI) types and channel types among the cell groups;
determining if UCI is carried on a physical uplink shared channel (PUSCH) transmission for a cell group;
determining if total transmission power of all cell groups with UCI-only transmissions exceeds the maximum allowed transmission power of the UE; and
transmitting UCI and channels on the cell groups.

19. The method of claim 18, wherein if the total scheduled transmission power of the cell groups exceeds the maximum allowed transmission power of the UE, and if UCI is carried on a PUSCH transmission for a first cell group, and if a total transmission power of all cell groups with a UCI-only transmission on a PUSCH of the first cell group does not exceed the maximum allowed transmission power of the UE, then the method further comprises:
transmitting the UCI only on the PUSCH of the first cell group.

20. The method of claim 18, wherein if the total scheduled transmission power of the cell groups exceeds the maximum allowed transmission power of the UE, and if UCI is carried on a PUSCH transmission for a first cell group, and if a total transmission power of all cell groups with a UCI-only transmission on a PUSCH of the first cell group exceeds the maximum allowed transmission power of the UE, then the method further comprises:
transmitting a channel with a higher priority in one cell group; and
dropping or power scaling the channel of the other cell group.

21. The method of claim 18, wherein if the total scheduled transmission power of the cell groups exceeds the maximum allowed transmission power of the UE, and if UCI is carried on a PUSCH transmission for a first cell group, and if a total transmission power of all the cell groups with UCI on a physical uplink control channel (PUCCH) of the first cell group does not exceed the maximum allowed transmission power of the UE, then the method further comprises:
transmitting the UCI on the PUCCH of the first cell group; and
dropping the PUSCH transmission of the first cell group.

22. The method of claim 18, wherein if the total scheduled transmission power of the cell groups exceeds the maximum allowed transmission power of the UE, and if UCI is carried on a PUSCH transmission for a first cell group, and if a total transmission power of all cell groups with UCI on a PUCCH of the first cell group exceeds the maximum allowed transmission power of the UE, then the method further comprises:
transmitting the channel with a higher priority in one cell group; and
dropping or power scaling the channel on the other cell group.

23. The method of claim 18, wherein if the total scheduled transmission power of the cell groups exceeds the maximum allowed transmission power of the UE, and if UCI is carried on a PUSCH transmission for a secondary cell group (SCG), and if a total transmission power of all cell groups with a UCI-only transmission on a PUSCH of the SCG does not exceed the maximum allowed transmission power of the UE, then the method further comprises:
transmitting the UCI only on the PUSCH of the SCG.

24. The method of claim 18, wherein if the total scheduled transmission power of the cell groups exceeds the maximum allowed transmission power of the UE, and if UCI is carried on a PUSCH transmission for a secondary cell group (SCG), and if a total transmission power of all cell groups with the UCI on a physical uplink control channel (PUCCH) of the SCG instead of a PUSCH of the SCG does not exceed the maximum allowed transmission power of the UE, then the method further comprises:
transmitting the UCI on the PUCCH of the SCG instead of the PUSCH of the SCG; and
dropping the PUSCH transmission of the SCG.

25. The method of claim 18, wherein if the total scheduled transmission power of the cell groups exceeds the maximum allowed transmission power of the UE, and if UCI is carried on a PUSCH transmission for a secondary cell group (SCG), and if a total transmission power of all cell groups with the UCI on a physical uplink control channel (PUCCH) of the SCG instead of a PUSCH of the SCG exceeds the maximum allowed transmission power of the UE, then the method further comprises:
dropping or power scaling the PUSCH with the UCI on the SCG.

26. The method of claim 18, wherein if the total scheduled transmission power of the cell groups exceeds the maximum allowed transmission power of the UE, and if the total transmission power of PUSCH transmissions without UCI of serving cells of a secondary cell group (SCG) exceeds the maximum allowed transmission power of the UE minus allocated power for a master cell group (MCG) minus at least one of a physical uplink control channel (PUCCH) transmission with UCI or a PUSCH transmission with UCI of the serving cell of the SCG, then the method further comprises:
dropping or power scaling the PUSCH without UCI on the SCG.

27. A method for dual-connectivity operation by an evolved NodeB (eNB), comprising:
determining that dual-connectivity is configured with more than one cell group; and
receiving uplink control information (UCI) and channels on a cell group, wherein the receiving is based on different assumptions of:
whether a total scheduled transmission power of the cell groups exceeds a maximum allowed transmission power of a user equipment (UE);
a priority of UCI types and channel types among the cell groups;
whether UCI is carried on a physical uplink shared channel (PUSCH) transmission for a cell group; and
whether a total transmission power of all cell groups with UCI-only transmissions exceeds the maximum allowed transmission power of the UE.

28. The method of claim 27, wherein if the total scheduled transmission power of the cell groups exceeds the maximum allowed transmission power of the UE, and if UCI is carried on a PUSCH transmission for a first cell group, then the method further comprises:
receiving UCI only on a PUSCH of the first cell group when a total transmission power of all cell groups with a UCI-only transmission on a PUSCH of the first cell group does not exceed the maximum allowed transmission power of the UE.

29. The method of claim 27, wherein if the total scheduled transmission power of the cell groups exceeds the maximum allowed transmission power of the UE, and if UCI is carried on a PUSCH transmission for a first cell group, then the method further comprises:
receiving a channel with a higher priority in one cell group when a total transmission power with a UCI-only transmission on a PUSCH of the first cell group exceeds the maximum allowed transmission power of the UE, wherein the channel of the other cell group is dropped or power scaled.

30. The method of claim 27, wherein if the total scheduled transmission power of the cell groups exceeds the maximum allowed transmission power of the UE, and if UCI is carried on a PUSCH transmission for a first cell group, then the method further comprises:
receiving the UCI on a physical uplink control channel (PUCCH) of the first cell group when a total transmission power of all cell groups with UCI on the PUCCH of the first cell group does not exceed the maximum allowed transmission power of the UE, wherein the PUSCH transmission of the first cell group is dropped.

31. The method of claim 27, wherein if the total scheduled transmission power of the cell groups exceeds the maximum allowed transmission power of the UE, and if UCI is carried on a PUSCH transmission for a first cell group, then the method further comprises:
receiving the channel with a higher priority in one cell group when a total transmission power of all cell groups with UCI on a physical uplink control channel (PUCCH) of the first cell group exceeds the maximum allowed transmission power of the UE, wherein the channel of the other cell group is dropped or power scaled.

32. The method of claim 27, wherein if the total scheduled transmission power of the cell groups exceeds the maximum allowed transmission power of the UE, and if UCI is carried on a PUSCH transmission for a secondary cell group (SCG), then the method further comprises:
receiving the UCI only on the PUSCH of the SCG when a total transmission power of all cell groups with a UCI-only transmission on a PUSCH of the SCG does not exceed the maximum allowed transmission power of the UE.

33. The method of claim 27, wherein if the total scheduled transmission power of the cell groups exceeds the maximum allowed transmission power of the UE, and if UCI is carried on a PUSCH transmission for a secondary cell group (SCG), then the method further comprises:
receiving the UCI on a physical uplink control channel (PUCCH) of the SCG instead of the PUSCH of the SCG when a total transmission power of all cell groups with the UCI on a PUCCH of the SCG instead of the PUSCH of the SCG does not exceed the maximum allowed transmission power of the UE, wherein the PUSCH transmission of the SCG is dropped.
